(19) United States
(12) Patent Application Publication
(10) Pub. No.: US 2014/0164313 A1
(43) Pub. Date: Jun. 12, 2014

(54) Method and Apparatus for Predicting Subject Responses to a Proposition based on Quantum Representation of the Subject's Internal State and of the Proposition

(71) Applicant: Invent.ly LLC, Woodside, CA (US)

(72) Inventors: Marek Alboszta, Montara, CA (US); Stephen J. Brown, Woodside, CA (US)

(73) Assignee: Invent.ly LLC, Woodside, CA (US)

(21) Appl. No.: 14/182,281

(22) Filed: Feb. 17, 2014

(51) Int. Cl. G06N 7/00; G06N 99/00

(52) U.S. Cl. CPC G06N 7/005; G06N 99/002
USPC 706/52

(57) ABSTRACT

The present invention is an apparatus and method for predicting the reactions of a subject, e.g., a human being to a proposition posed to the subject during a subject-object or a subject-subject interaction that takes place online or in real life. The quantum mechanical model adopted herein assigns a first subject qubit |iss1> to a primary internal state of the subject with eigenvalues corresponding to measurable indications a, b of the primary internal state. A response qubit |rsp> that can yield at least two mutually exclusive responses corresponding to two eigenvalues is also assigned to the subject. A proposition matrix PR in the form of a linear operator designed to act on response qubit |rsp> is assigned to enable a quantum mechanical derivation of response probabilities and expectation values for response to the same underlying proposition in various contexts, including incompatible contexts in the Heisenberg sense.

### FIELD OF THE INVENTION

The present invention relates to a method and an apparatus for predicting the reactions of a subject, e.g., a human being, to a proposition posed to the subject during a subject-object or a subject-subject interaction that takes place online or in real life. The underlying prediction model adopts a quantum representation of subject internal states and of the proposition by assigning them to qubits (quantum bits) so as to accommodate reactions that include different sets of mutually exclusive responses by the same subject modulo the same underlying proposition presenting to the subject in incompatible contexts.

### BACKGROUND OF THE INVENTION

### 1. Preliminary Overview

The insights into the workings of nature at micro-scale were captured by quantum mechanics over a century ago. These new realizations have since precipitated fundamental revisions to our picture of reality. A particularly difficult to accept change involves the inherently statistical aspects of quantum theory. Many preceding centuries of progress rooted in logical and positivist extensions of the ideas of materialism had certainly biased the human mind against the implications of the new theory. After all, it is difficult to relinquish strong notions about the existence of as-yet-undiscovered and more fundamental fully predictive description(s) of microscopic phenomena in favor of quantum's intrinsically statistical model for the emergence of measurable quantities.

Perhaps unsurprisingly, the empirically driven transition from classical to quantum thinking has provoked strong reactions among numerous groups. Many have spent considerable effort in unsuccessful attempts to attribute the statistical nature of quantum mechanics to its incompleteness. Others still attempt to interpret or reconcile it with entrenched classical intuitions rooted in Newtonian physics. However, the deep desire to contextualize quantum mechanics within a larger and more “intuitive” or even quasi-classical framework has resulted in few works of practical significance.

Meanwhile, quantum mechanics, given its exceptional agreement with fact and its explanatory power, has managed to defy all struggles at a classical reinterpretation. Today, quantum mechanics and the consequent quantum theory of fields (its extension and partial integration with relativity theory) have proven to be humanity's best fundamental theories of nature. Sub-atomic, atomic and many molecular phenomena are now studied based on quantum or at least quasi-quantum models of reality.

In a radical departure from classical assumption of perpetually existing and measurable quantities, quantum representation of reality posits new entities called wavefunctions or state vectors. These unobservable components of the new model of reality are prior to the emergence of measured quantities or facts. More precisely, state vectors are related to distributions of probabilities for observing any one of a range of possible experimental results. A telltale sign of the “non-physical” status of a state vector is captured in the language of mathematics, where typical state vectors are expressed as imaginary-valued objects. Further, the space spanned by such state vectors is not classical (i.e., it is not our familiar Euclidean space or even any classical configuration space such as phase space). Instead, state vectors inhabit a Hilbert space of square-integrable functions.

Given that state vectors represent complex probability amplitudes, it may appear surprising that their behavior is rather easily reconciled with previously developed physics formalisms. Indeed, after some revisions the tools of Lagrangian and Hamiltonian mechanics as well as many long-standing physical principles, such as the Principle of Least Action, are found to apply directly to state vectors and their evolution. The stark difference, of course, is that state vectors themselves represent relative propensities for observing certain measurable values associated with the objects of study, rather than these measurable quantities themselves. In other words, whereas the classical formulations, including Hamiltonian or Lagrangian mechanics, were originally devised to describe the evolution of “real” entities, their quantum mechanical equivalents apply to the evolution of probability amplitudes. Apart from that jarring fact, when left unobserved the state vectors prove to be rather well-behaved. Indeed, their continuous and unitary evolution in Hilbert space is not entirely unlike propagation of real waves in plain Euclidean space. Thus, some of our intuitions about classical wave mechanics are useful in grasping the behavior of quantum waves.

Of course, our intuitive notions about wave mechanics ultimately break down because quantum waves are not physical waves. This becomes especially clear when considering superpositions of two or more such complex-valued objects. In fact, considering such superpositions helps to bring out several unexpected aspects of quantum mechanics.

For example, quantum wave interference predicts the emergence of probability interference patterns that lead to unexpected distributions of measureable entities in real space, even when dealing with well-known particles and their trajectories. This effect is probably best illustrated by the famous Young's double slit experiment. Here, the complex phase differences between quantum mechanical waves propagating from different space points, namely the two slits where the particle wave was forced to bifurcate, manifest in a measurable effect on the path followed by the physical particle. Specifically, the particle is predicted to exhibit a type of self-interference that prevents it from reaching certain places that lie manifestly along classically computed particle trajectories. These quantum effects are confirmed by fact.

Although surprising, wave superpositions and interference patterns are ultimately not the novel aspects that challenged human intuition most. Far more mysterious is the nature of measurement during which a real value of an observable attribute of an element of reality is actually observed.

While the underlying model of pre-emerged reality constructed of quantum waves governed by differential wave equations (e.g., the Schroedinger equation) and boundary conditions may be at least partly intuitive, measurement itself defies attempts at non-probabilistic description. According to quantum theory, the act of measurement forces the full state vector or wave packet of all possibilities to “collapse” or choose just one of the possibilities. In other words, measurement forces the normally compound wave function (i.e., a superposition of possible wave solutions to the governing differential equation) to transition discontinuously and manifest as just one of its constituents. Still differently put, measurement reduces the wave packet and selects only one component wave from the full packet that represents the superposition of all component waves contained in the state vector.

In order to properly evaluate the state of the prior art and to contextualize the contributions of the present invention, it will be necessary to review a number of important concepts from quantum mechanics, quantum information theory (e.g., the quantum version of bits also called “qubits” by skilled artisans) and several related fields. For the sake of brevity, only the most pertinent issues will be presented herein. For a more thorough review of quantum information theory the reader is referred to course materials for John P. Preskill, “Quantum Information and Computation”, Lecture Notes Ph219/CS219, Chapters 2&3, California Institute of Technology, 2013 and references cited therein. Excellent reviews of the fundamentals of quantum mechanics are found in standard textbooks starting with P. A. M. Dirac, “The Principles of Quantum Mechanics”, Oxford University Press, 4^{th} Edition, 1958; L. D. Landau and E. M. Lifshitz, “Quantum Mechanics (Non-relativistic Theory)”, Institute of Physical Problems, USSR Academy of Sciences, Butterworth Heinemann, 3^{rd} Edition, 1962; Cohen-Tannoudji et al., “Quantum Mechanics”, John Wiley & Sons, 1977, and many others including the more in-depth and modern treatments such as J. J. Sakurai, “Modern Quantum Mechanics”, Addison-Wesley, 2011.

### 2. A Brief Review of Quantum Mechanics Fundamentals

In most practical applications of quantum models, the process of measurement is succinctly and elegantly described in the language of linear algebra or matrix mechanics (frequently referred to as the Heisenberg picture). Since all those skilled in the art are familiar with linear algebra, many of its fundamental theorems and corollaries will not be reviewed herein. In the language of linear algebra, a quantum wave ψ is represented in a suitable eigenvector basis by a state vector |ψ [symbol] . To provide a more rigorous definition, we will take advantage of the formal bra-ket notation used in the art.

In keeping with Dirac's bra-ket convention, a column vector α is written as |α [symbol] and its corresponding row vector (dual vector) is written as [symbol] a|. Additionally, because of the complex-valuedness of quantum state vectors, flipping any bra vector to its dual ket vector and vice versa implicitly includes the step of complex conjugation. After initial introduction, most textbooks do not expressly call out this step (i.e., [symbol] a| is really [symbol] a| where the asterisk denotes complex conjugation). The reader is cautioned that many simple errors can be avoided by recalling this fundamental rule of complex conjugation.

We now recall that a measure of norm or the dot product (which is related to a measure of length and is a scalar quantity) for a standard vector \vec{x} is normally represented as a multiplication of its row vector form by its column vector form as follows: d=\vec{x}^{T}\vec{x}. This way of determining norm carries over to the bra-ket formulation. In fact, the norm of any state vector carries a special significance in quantum mechanics.

Expressed by the bra-ket [symbol] a|a [symbol] , we note that this formulation of the norm is always positive definite and real-valued for any non-zero state vector. That condition is assured by the step of complex conjugation when switching between bra and ket vectors. Now, state vectors describe probability amplitudes while their norms correspond to probabilities. The latter are real-valued and by convention mapped to a range between 0 and 1 (with 1 representing a probability of 1 or 100% certainty). Correspondingly, all state vectors are typically normalized such that their inner product (a generalization of the dot product) is equal to one, or simply put: [symbol] a|a [symbol] = [symbol] β|β [symbol] = . . . =1. This normalization enforces conservation of probability on objects composed of quantum mechanical state vectors.

Using the above notation, we can represent any state vector |ψ [symbol] in its ket form as a sum of basis ket vectors |εⱼ [symbol] that span the Hilbert space [symbol] of state vector |ψ [symbol] . In this expansion, the basis ket vectors |εⱼ [symbol] are multiplied by their correspondent complex coefficients cⱼ. In other words, state vector |ψ [symbol] decomposes into a linear combination as follows:

|ψ [symbol] =Σⱼ₌₁ⁿcⱼ|εⱼ) Eq. 1

where n is the number of vectors in the chosen basis. This type of decomposition of state vector |ψ [symbol] is sometimes referred to as its spectral decomposition by those skilled in the art.

Of course, any given state vector |ψ [symbol] can be composed from a linear combination of vectors in different bases thus yielding different spectra. However, the normalization of state vector |ψ [symbol] is equal to one irrespective of its spectral decomposition. In other words, bra-ket [symbol] ψ|ψ [symbol] =1 in any basis. From this condition we learn that the complex coefficients cⱼ of any expansion have to satisfy:

pₜₒₜ=1=Σⱼ₌₁ⁿcⱼ*cⱼ Eq. 2

where pₜₒₜ is the total probability. This ensures the conservation of probability, as already mentioned above. Furthermore, it indicates that the probability pⱼ associated with any given eigenvector |εⱼ [symbol] in the decomposition of |ψ [symbol] is the norm of the complex coefficient cⱼ, or simply put:

pⱼ=cⱼ*cⱼ Eq. 3

In view of the above, it is not surprising that undisturbed evolution of any state vector |ψ [symbol] in time is found to be unitary or norm preserving. In other words, the evolution is such that the norms cⱼ*cⱼ do not change with time.

To better understand the last point, we use the polar representation of complex numbers by their modulus r and phase angle θ. Thus, we rewrite complex coefficient cⱼ as:

cⱼ==rⱼe^{iθ}^{ⱼ} Eq. 4a

where i=\sqrt{−1} (we use i rather than j for the imaginary number). In this form, complex conjugate of complex coefficient cⱼ* is just:

cⱼ*==rⱼe^{-iθ}^{ⱼ} Eq. 4b

and the norm becomes:

cⱼ*cⱼ==rⱼe^{-iθ}^{ⱼ}rⱼe^{iθ}^{ⱼ}=rⱼ². Eq. 4c

The step of complex conjugation thus makes the complex phase angle drop out of the product (since e^{-iθ}e^{iθ}=e^{i(θ-θ)}=e⁰=1). This means that the complex phase of coefficient cⱼ does not have any measurable effects on the real-valued probability pⱼ associated with the corresponding eigenvector |εⱼ [symbol] , however, that relative phases between different components of the decomposition will introduce measurable effects (e.g., when measuring in a different basis).

In view of the above insight about complex phases, it is perhaps unsurprising that temporal evolution of state vector |ψ [symbol] corresponds to the evolution of phase angles of complex coefficients cⱼ in its spectral decomposition (see Eq. 1). In other words, evolution of state vector |ψ [symbol] in time is associated with a time-dependence of angles θⱼ of each complex coefficient cⱼ. The complex phase thus exhibits a time dependence e^{iθ}^{ⱼ}=e^{iω}^{ⱼ}^{t}, where the j-th angular frequency ωⱼ is associated with the j-th eigenvector |εⱼ [symbol] and t stands for time. For completeness, it should be pointed out that ωⱼ is related to the energy level of the correspondent eigenvector |εⱼ [symbol] by the famous Planck relation:

Eⱼ=hωⱼ, Eq. 5

where stands for the reduced Planck's constant h, namely:

$$ℏ = \frac{h}{2 π} .$$

Correspondingly, evolution of state vector |ψ [symbol] is encoded in a unitary matrix U that acts on state vector |ψ [symbol] in such a way that it only affects the complex phases of the eigenvectors in its spectral decomposition. The unitary nature of evolution of state vectors ensures the fundamental conservation of probability.

In contrast to the unitary evolution of state vectors that affects the complex phases of all eigenvectors of the state vector's spectral decomposition, the act of measurement picks out just one of the eigenvectors. Differently put, the act of measurement is related to a projection of the full state vector |ψ [symbol] onto the subspace defined by just one of eigenvectors |εⱼ [symbol] in the vector's spectral decomposition (see Eq. 1). Based on the laws of quantum mechanics, the projection obeys the laws of probability. More precisely, each eigenvector |εⱼ [symbol] has the probability pⱼ dictated by the norm cⱼ*cⱼ (see Eq. 3) of being picked for the projection induced by the act of measurement. Besides the rules of probability, there are no hidden variables or any other constructs involved in predicting the projection. This situation is reminiscent of a probabilistic game such as a toss of a coin or the throw of a die. It is also the reason why Einstein felt uncomfortable with quantum mechanics and proclaimed that he did not believe that God would “play dice with the universe”.

No experiments to date have been able to validate Einstein's position by discovering hidden variables or other predictive mechanisms behind the choice. In fact, experiments based on the famous Bell inequality and many other investigations have confirmed that the above understanding encapsulated in the projection postulate of quantum mechanics is complete. Furthermore, once the projection occurs due to the act of measurement, the emergent element of reality that is observed, i.e., the measurable quantity, is the eigenvalue λⱼ associated with eigenvector |εⱼ [symbol] selected by the projection.

Projection is a linear operation represented by a projection matrix P that can be derived from knowledge of the basis vectors. The simplest state vectors decompose into just two distinct eigenvectors in any given basis. These vectors describe the spin states of spin ½ particles such as electrons and other spinors. The quantum states of twistors, such as photons, also decompose into just two eigenvectors. In the present case, we will refer to spinors for reasons of convenience.

It is customary to define the state space of a spinor by eigenvectors of spin along the z-axis. The first, |_{z+} [symbol] is aligned along the positive z-axis and the second, |ε_{z-} [symbol] is aligned along the negative z-axis. Thus, from standard rules of linear algebra, the projection along the positive z-axis (z+) can be obtained from constructing the projection matrix or, in the language of quantum mechanics the projection operator P_{z+} from the z+ eigenvector |ε_{z+}) as follows:

$${P}_{z +} = \vert {ɛ}_{z +} 〉 〈 {ɛ}_{z +} \vert = {[ \begin{matrix}1 \\ 0\end{matrix} ] [ 1 \; 0 ]}^{*} = [ \begin{matrix}1 & 0 \\ 0 & 0\end{matrix} ] , \qquad Eq . 6$$

where the asterisk denotes complex conjugation, as above (no change here because vector components of |ε_{z+} [symbol] are not complex in this example). Note that in Dirac notation obtaining the projection operator is analogous to performing an outer product in standard linear algebra. There, for a vector \vec{x} we get the projection matrix onto it through the outer product, namely: Pₓ=\vec{x}\vec{x}^{T}.

### 3. A Brief Introduction to Qubits

We have just seen that the simplest quantum state vector |ψ [symbol] corresponds to a pre-emerged quantum entity that can yield one of two distinct observables under measurement. These measures are the two eigenvalues λ₁, λ₂ of the correspondent two eigenvectors |ε₁ [symbol] , |ε₂ [symbol] in the chosen spectral decomposition. The relative occurrence of the eigenvalues will obey the probabilistic rule laid down by the projection postulate. In particular, eigenvalue λ₁ will be observed with probability p₁ (see Eq. 3) equal to the probability of projection onto eigenvector |ε₁ [symbol] . Eigenvalue λ₂ will be seen with probability p₂ equal to the probability of projection onto eigenvector |ε₂ [symbol] .

Because of the simplicity of the two-state quantum system represented by such two-state vector |ψ [symbol] , it has been selected in the field of quantum information theory and quantum computation as the fundamental unit of information. In analogy to the choice made in computer science, this system is commonly referred to as a qubit and so the two-state vector becomes the qubit: |qb [symbol] =|ψ [symbol] . Operations on one or more qubits are of great interest in the field of quantum information theory and its practical applications. Since the detailed description will rely extensively on qubits and their behavior, we will now introduce them with a certain amount of rigor.

From the above preliminary introduction it is perhaps not surprising to find that the simplest two-state qubit, just like a simple spinor or twistor on which it is based, can be conveniently described in 2-dimensional complex space called [symbol] ². The description finds a more intuitive translation to our 3-dimensional space, [symbol] ³, with the aid of the Bloch or Poincare Sphere. This concept is introduced by FIG. 1A, in which the Bloch Sphere 10 is shown centered on the origin of orthogonal coordinates indicated by axes X, Y, Z.

Before allowing oneself to formulate an intuitive view of qubits by looking at Bloch sphere 10, the reader is cautioned that the representation of qubits inhabiting [symbol] ² by mapping them to a ball in [symbol] ³ is a useful tool. The actual mapping is not one-to-one. Formally, the representation of spinors by the group of transformations defined by SO(3) (Special Orthogonal matrices in [symbol] ³) is double-covered by the group of transformations defined by SU(2) (Special Unitary matrices in [symbol] ²).

In the Bloch representation, a qubit 12 represented by a ray in [symbol] ² is spectrally decomposed into the two z-basis eigenvectors. These eigenvectors include the z-up or |+ [symbol] _{z} eigenvector, and the z-down or |− [symbol] _{z} eigenvector. The spectral decomposition theorem assures us that any state of qubit 12 can be decomposed in the z-basis as long as we use the appropriate complex coefficients. In other words, any state of qubit 12 in the z-basis can be described by:

|ψ [symbol] _{z}=|qb [symbol] _{z}=α|+ [symbol] _{z}+β|− [symbol] _{z}, Eq. 7

where α and β are the corresponding complex coefficients. In quantum information theory, basis state |+_{z} is frequently mapped to logical “yes” or to the value “1”, while basis state |−_{z} is frequently mapped to logical “no” or to the value “0”.

In FIG. 1A basis states |+ [symbol] _{z} and |− [symbol] _{z} are shown as vectors and are written out in full form for clarity of explanation. (It is worth remarking that although basis states |+ [symbol] _{z} and |− [symbol] _{z} are indeed orthogonal in [symbol] ², they fall on the same axis (Z axis) in the Bloch sphere representation in [symbol] ³. That is because the mapping is not one-to-one, as already mentioned above.) Further, in our chosen representation of qubit 12 in the z-basis, the X axis corresponds to the real axis and is thus also labeled by Re. Meanwhile, the Y axis corresponds to the imaginary axis and is additionally labeled by Im.

To appreciate why complex coefficients α and β contain sufficient information to encode qubit 12 pointed anywhere within Bloch sphere 10 we now refer to FIG. 1B. Here the complex plane 14 spanned by real and imaginary axes Re, Im that are orthogonal to the Z axis and thus orthogonal to eigenvectors |+ [symbol] _{z} and |− [symbol] _{z} of our chosen z-basis is hatched for better visualization. Note that eigenvectors for the x-basis |+ [symbol] ₓ, | [symbol] ₓ as well as eigenvectors for the y-basis |+ [symbol] _{y}, |− [symbol] _{y} are in complex plane 14. Most importantly, note that each one of the alternative basis vectors in the two alternative basis choices we could have made finds a representation using the eigenvectors in the chosen z-basis. As shown in FIG. 1B, the following linear combinations of eigenvectors |+ [symbol] _{z} and |− [symbol] _{z} describe vectors |+ [symbol] ₓ, |− [symbol] ₓ and |+ [symbol] _{y}, |− [symbol] _{y}:

$$\begin{matrix}{\vert + 〉}_{x} = \frac{1}{\sqrt{2}} {\vert + 〉}_{z} + \frac{1}{\sqrt{2}} {\vert - 〉}_{z} , & Eq . 8 a \\ {\vert - 〉}_{x} = \frac{1}{\sqrt{2}} {\vert + 〉}_{z} - \frac{1}{\sqrt{2}} {\vert - 〉}_{z} , & Eq . 8 b \\ {\vert + 〉}_{y} = \frac{1}{\sqrt{2}} {\vert + 〉}_{z} + \frac{i}{\sqrt{2}} {\vert - 〉}_{z} , & Eq . 8 c \\ {\vert - 〉}_{y} = \frac{1}{\sqrt{2}} {\vert + 〉}_{z} - \frac{i}{\sqrt{2}} {\vert - 〉}_{z} , & Eq . 8 d\end{matrix}$$

Clearly, admission of complex coefficients α and β permits a complete description of qubit 12 anywhere within Bloch sphere 10 thus furnishing the desired map from [symbol] ² to [symbol] ² for this representation. The representation is compact and leads directly to the introduction of Pauli matrices.

FIG. 1C shows the three Pauli matrices σₗ, σ₂, σ₃ (sometimes also referred to as σₓ, σ_{y}, σ_{z}) that represent the matrices corresponding to three different measurements that can be performed on spinors. Specifically, Pauli matrix σ₁ corresponds to measurement of spin along the X axis (or the real axis Re). Pauli matrix σ₂ corresponds to measurement of spin along the Y axis (or the imaginary axis Im). Finally, Pauli matrix σ₃ corresponds to measurement of spin along the Z axis (which coincides with measurements in the z-basis that we have selected). The measurement of spin along any of these three orthogonal axes will force projection of qubit 12 to one of the eigenvectors of the corresponding Pauli matrix. Correspondingly, the measurable value will be the eigenvalue that is associated with the eigenvector.

To appreciate the possible outcomes of measurement we notice that all Pauli matrices σₗ, σ₂, σ₃ share the same two orthogonal eigenvectors, namely |ε₁ [symbol] =[1,0] and |ε₂ [symbol] =[0,1]. Further, Pauli matrices are Hermitian (an analogue of real-valued symmetric matrices) such that:

σₖ=σₖ^{†}, Eq. 9

for k=1, 2, 3 (for all Pauli matrices). These properties ensure that the eigenvalues λ₁, λ₂, λ₃ of Pauli matrices are real and the same for each Pauli matrix. In particular, for spin ½ particles such as electrons, the Pauli matrices are multiplied by a factor of /2 to obtain the corresponding spin angular momentum matrices Sₖ. Hence,

$${λ}_{1} = \frac{h}{2} and {λ}_{2} = - \frac{h}{2}$$

the eigenvalues are shifted to (where is the reduced Planck's constant already defined above). Here we also notice that Pauli matrices σₗ, σ₂, σ₃ are constructed to apply to spinors, which change their sign under a 2π rotation and require a rotation by 4π to return to initial state (formally, an operator S is a spinor if S(θ+2π=−S(θ)).

As previously pointed out, in quantum information theory and its applications the physical aspect of spinors becomes unimportant and thus the multiplying factor of /2 is dropped. Pauli matrices σ₁, σ₂, σ₃ are used in unmodified form with corresponded eigenvalues λ₁=1 and λ₂=−1 mapped to two opposite logical values, such as “yes” and “no”. For the sake of rigor and completeness, one should state that the Pauli marices are traceless, each of them squares to the Identity matrix I, their determinants are −1 and they are involutory. A more thorough introduction to their importance and properties can be found in the many foundational texts on Quantum Mechanics, including the above mentioned textbook by P. A. M. Dirac, “The Principles of Quantum Mechanics”, Oxford University Press, 4^{th} Edition, 1958 in the section on the spin of the electron.

Based on these preliminaries, the probabilistic aspect of quantum mechanics encoded in qubit 12 can be re-stated more precisely. In particular, we have already remarked that the probability of projecting onto an eigenvector of a measurement operator is proportional to the norm of the complex coefficient multiplying that eigenvector in the spectral decomposition of the full state vector. This rather abstract statement can now be recast as a complex linear algebra prescription for computing an expectation value [symbol] O [symbol] of an operator matrix O for a given quantum state |ψ [symbol] as follows:

[symbol]

O [symbol] _{ψ}= [symbol] ψ|O|ψ [symbol] , Eq. 10a

where the reader is reminded of the implicit complex conjugation between the bra vector [symbol] ψ| and the dual ket vector |ψ [symbol] . The expectation value [symbol] O [symbol] _{ψ} is a number that corresponds to the average result of the measurement obtained by operating with matrix O on a system described by state vector |ψ [symbol] . For better understanding, FIG. 1C visualizes the expectation value [symbol] σ₃ [symbol] for qubit 12 whose ket in the z-basis is written as |qb [symbol] _{z} for a measurement along the Z axis represented by Pauli matrix σ₃ (note that the subscript on the expectation value is left out, since we know what state vector is being measured).

Although the drawing may suggests that expectation value [symbol] σ₃ [symbol] is a projection of qubit 12 onto the Z axis, the value of this projection is not the observable. Instead, the value [symbol] σ₃ [symbol] is the expectation value of collapse of qubit 12 represented by ket vector |qb [symbol] _{z}, in other words, a value that can range anywhere between 1 and −1 (“yes” and “no”) and will be found upon collecting the results of a large number of actual measurements.

In the present case, since operator σ₃ has a complete set of eigenvectors (namely |+ [symbol] _{z} and |− [symbol] _{z}) and since the qubit |qb [symbol] _{z} we are interested in is described in the same z-basis, the probabilities are easy to compute. The expression follows directly from Eq. 10a:

[symbol]

σ_{ψ}=Σⱼλⱼ| [symbol] ψ|εⱼ [symbol] |², Eq. 10b

where λⱼ are the eigenvalues (or the “yes” and “no” outcomes of the experiment) and the norms | [symbol] ψ|εⱼ [symbol] |² are the probabilities that these outcomes will occur. Eq. 10b is thus more useful for elucidating how the expectation value of an operator brings out the probabilities of collapse to respective eigenvectors |εⱼ [symbol] that will obtain when a large number of measurements are performed in practice.

For the specific case in FIG. 1C, we show the probabilities from Eq. 10b can be found explicitly in terms of the complex coefficients α and β. Their values are computed from the definition of quantum mechanical probabilities already introduced above (see Eqs. 2 and 3):

p₁═p_{“yes”}=| [symbol] qb|ε₁ [symbol] |²=|(α* [symbol] +|+β* [symbol] −|)|+ [symbol] _{z}|²=α*α

p₂═p_{“no”}=| [symbol] qb|ε₂ [symbol] |²=|(α* [symbol] +|+β* [symbol] −|)|+ [symbol] _{z}|²=β*β

p₁+p₂=p_{“yes”}+p_{“no”}=α*α+β*β=1

These two probabilities are indicated by visual aids at the antipodes of Bloch sphere 10 for clarification. The sizes of the circles that indicate them denote their relative values. In the present case p_{“yes”}>p_{“no”} given the exemplary orientation of qubit 12.

Representation of qubit 12 in Bloch sphere 10 brings out an additional and very useful aspect to the study, namely a more intuitive polar representation. This representation will also make it easier to point out several important aspects of quantum mechanical states that will be pertinent to the present invention.

FIG. 1D illustrates qubit 12 by deploying polar angle θ and azimuthal angle φ routinely used to parameterize the surface of a sphere in [symbol] . Qubit 12 described by state vector |qb [symbol] _{z} has the property that its vector representation in Bloch sphere 10 intersects the sphere's surface at point 16. That is apparent from the fact that the norm of state vector |qb [symbol] _{z} is equal to one and the radius of Bloch sphere 10 is also one. Still differently put, qubit 12 is represented by quantum state |qb [symbol] _{z} that is pure; i.e., it is considered in isolation from the environment and from any other qubits for the time being. Pure state |qb [symbol] _{z} is represented with polar and azimuth angles θ, φ of the Bloch representation as follows:

$${\vert qb 〉}_{z} = cos \frac{θ}{2} {\vert + 〉}_{z} + {e}^{i φ} sin \frac{θ}{2} {\vert - 〉}_{z} , \qquad Eq . 11$$

where the half-angles are due to the state being a spinor (see definition above). The advantage of this description becomes even more clear in comparing the form of Eq. 11 with Eq. 7. State |qb [symbol] _{z} is insensitive to any overall phase or overall sign thus permitting several alternative formulations.

Additionally, we note that the Bloch representation of qubit 12 also provides an easy parameterization of point 16 in terms of {x,y,z} coordinates directly from polar and azimuth angles θ, φ. In particular, the coordinates of point 16 are just:

{x,y,z}={sin θ cos φ, sin θ sin φ, cos θ}, Eq. 12

in agreement with standard transformation between polar and Cartesian coordinates.

We now return to the question of measurement equipped with some basic tools and a useful representation of qubit 12 as a unit vector terminating at the surface of Bloch sphere 10 at point 16 (whose coordinates {x,y,z} are found from Eq. 12) and pointing in some direction characterized by angles θ, φ. The three Pauli matrices σ₁, σ₂, σ₃ can be seen as associating with measurements along the three orthogonal axes X, Y, Z in real 3-dimensional space [symbol] ³.

A measurement represented by a direction in [symbol] ³ can be constructed from the Pauli matrices. This is done with the aid of a unit vector û pointing along a proposed measurement direction, as shown in FIG. 1D. Using the dot-product rule, we now compose the desired operator σᵤ using unit vector û and the Pauli matrices as follows:

σᵤ=û· σ̅=uₓσ₁+u_{y}σ₂+u_{z}σ₃. Eq. 13

Having thus built up a representation of quantum mechanical state vectors, we are in a position to understand a few facts about the pure state of qubit 12. Namely, an ideal or pure state of qubit 12 is represented by a Bloch vector of unit norm pointing along a well-defined direction. It can also be expressed by Cartesian coordinates {x,y,z} of point 16. Unit vector û defining any desired direction of measurement can also be defined in Cartesian coordinates {x,y,z} of its point of intersection 18 with Bloch sphere 10.

When the direction of measurement coincides with the direction of the state vector of qubit 12, or rather when the Bloch vector is aligned with unit vector û, the result of the quantum measurement will not be probabilistic. In other words, the measurement will yield the result |+ [symbol] ᵤ with certainty (probability equal to 1 as may be confirmed by applying Eq. 10b), where the subscript u here indicates the basis vector along unit vector û. Progressive misalignment between the direction of measurement and qubit 12 will result in an increasing probability of measuring the opposite state, |− [symbol] ᵤ.

The realization that it is possible to predict the value of qubit 12 with certainty under above-mentioned circumstances suggests we ask the opposite question. When do we encounter the least certainty about the outcome of measuring qubit 12? With the aid of FIG. 1E, we see that in the Bloch representation this occurs when we pick a direction of measurement along a unit vector û that is in a plane 20 perpendicular to unit vector û after establishing the state |+ [symbol] ᵤ (or in the state |− [symbol] ᵤ) by measuring qubit 12 eigenvalue “yes” along û (or “no” opposite to û). Note that establishing a certain state in this manner is frequently called “preparing the state” by those skilled in the art. Specifically, measurement of qubit 12 along vector \hat{v} will produce outcomes |+ [symbol] ᵥ and |− [symbol] ᵥ with equal probabilities (50/50).

Indeed, we see that this same condition holds among all three orthogonal measurements encoded in the Pauli matrices. To with, preparing a certain measurement along Z by application of matrix σ₃ to qubit 12 makes its subsequent measurement along X or Y axes maximally uncertain (see also plane 14 in FIG. 1B). This suggests some underlying relationship between Pauli matrices σₗ, σ₂, σ₃ that encodes for this indeterminacy. Even based on standard linear algebra we expect that since the order of application of matrix operations usually matters (since any two matrices A and B typically do not commute) the lack of commutation between Pauli matrices could be signaling a fundamental limit to the simultaneous observation of multiple orthogonal components of spin or, by extension, of qubit 12.

In fact, we find that the commutation relations for the Pauli matrices, here explicitly rewritten with the x,y,z indices rather than 1, 2, 3, are as follows:

[σₓ,σ_{y}]=iσ_{z}; [σ_{y},σ_{z}]=iσₓ; [σ_{z},σₓ]=iσ_{y} Eq. 14

The square brackets denote the traditional commutator defined between any two matrices A, B as [A,B]=AB-BA. When actual quantities rather than qubits are under study, this relationship leads directly to the famous Heisenberg Uncertainty Principle that prevents the simultaneous measurement of incompatible observables and places a bound related to Planck's constant h or on the commutator. This happens because matrices encoding real observables bring in a factor of Planck's constant h or and the commutator thus acquires this familiar bound.

The above finding is general and extends beyond the commutation relations between Pauli matrices. According to quantum mechanics, the measurement of two or more incompatible observables is always associated with matrices that do not commute. Another way to understand this new limitation on our ability to simultaneously discern separate elements of reality, is to note that the matrices for incompatible elements of reality cannot be simultaneously diagonalized. Differently still, matrices for incompatible elements of reality do not share the same eigenvectors. Given this fact of nature, it is clear why modern day applications strive to classify quantum systems with as many commuting observables as possible up to the famous Complete Set of Commuting Observables (CSCO).

### 4. Practical Situations, Mixed States and Real Data Sets

In practice, pure states are rare due to interactions between individual qubits as well as their coupling to the environment. All such interactions lead to a loss of quantum state coherency, also referred to as decoherence, and the consequent emergence of “classical” statistics. Thus, additional tools have been devised for practical applications of quantum models.

In practical applications it is typical to deal with collections of states that are large. This situation is illustrated by FIG. 1F, where an experimental apparatus 22 is set up to perform a measurement of spin along the Z axis. Apparatus 22 has two magnets 24A, 24B for separating a stream of quantum systems 26 (e.g., electrons) according to spin. The spin states of systems 26 are treated as qubits 12A, 12B, . . . , 12N for the purposes of the experiment. The eigenvectors and eigenvalues are as before, but the subscript “z” that was there to remind us of the z-basis decomposition, which is now implicitly assumed, has been dropped.

Apparatus 22 has detectors 28A, 28B that intercept systems 26 after separation to measure and amplify the readings. It is important to realize that the act of measurement is performed during the interaction between the field created between magnets 24A, 24B and systems 26. Therefore, detectors 28A, 28B are merely providing the ability to record and amplify the measurements for human use. These operations remain consistent with the original result of quantum measurements. Hence, their operation can be treated classically. (The careful reader will discover a more in-depth explanation of how measurement can be understood as entanglement that preserves consistency between measured events given an already completed micro-level measurement. By contrast, the naïve interpretation allowing amplification to lead to macro-level superpositions and quantum interference is incompatible with the consistency requirement. A detailed analysis of these fine points is found in any of the previously mentioned foundational texts on quantum mechanics.)

For systems 26 prepared in various pure states that are unknown to the experimenter, the measurements along Z will not be sufficient to deduce these original states. Consider that each system 26 is described by Eq. 7. Thus, each system 26 passing through apparatus 22 will be deflected according to its own distinct probabilities p_{|+} [symbol] =α*α (or p_{“yes”}) and p_{|-} [symbol] =β*β (or p_{“no”}). Thus, other than knowing the state of each system 26 with certainty after its measurement, general information about the preparation of systems 26 prior to measurement will be very difficult to deduce.

FIG. 1G shows the more common situation, where systems 26 are all prepared in the same, albeit unknown pure state (for “state preparation” see section 3 above). Under these circumstances, apparatus 22 can be used to deduce more about the original pure state that is unknown to the experimenter. In particular, a large number of measurements of |+ [symbol] (“yes”) and |− [symbol] (“no”) outcomes, for example N such measurements assuming all qubits 12A through 12N are properly measured, can be analyzed probabilistically. Thus, the number n of |+ [symbol] measurements divided by the total number of qubits 12, namely N, has to equal α*α. Similarly, the number n of 1) measurements divided by N has to equal β*β. From this information the experimenter can recover the projection of the unknown pure state onto the Z axis. In FIG. 1G this projection 26′ is shown as an orbit on which the state vector can be surmised to lie. Without any additional measurements, this is all the information that can be easily gleaned from a pure Z axis measurement with apparatus 22.

FIG. 1H illustrates another important aspect of the practical application of quantum models to bipartite systems or systems with two qubits 12 and 12′. Both qubits 12, 12′ are represented on Bloch spheres 10, 10′ and their state vectors are indicated by |qb1 [symbol] _{z} and |qb2 [symbol] _{z} in the common z-basis, respectively. Now, qubit 12 inhabits its own Hilbert space [symbol] _{qb1}, as previously defined. Similarly, qubit 12′ inhabits its Hilbert space [symbol] _{qb2}. One of the most fundamental questions in an experimental situation is the relationship between these two Hilbert spaces [symbol] _{qb1} and [symbol] _{qb2}.

In the present case, a partition 20 is used to visually indicate that Hilbert spaces [symbol] _{qb1}, [symbol] _{qb2} are not related. In other words, qubits 12, 12′ are described separately and they can exist in their own pure states of the type we have already examined above. In this situation we refer to qubits 12, 12′ as not entangled and we are fully entitled to treat each on its own without regard to the other. Differently put, we can apply the matrix operators independently to either state vector |qb1 [symbol] _{z} or state vector |qb2 [symbol] ^{z} without worrying about the relationship between qubits 12, 12′. Any probabilities involved in prediction of outcomes for both qubits 12, 12′ involve the simple product rule. Unfortunately, this ideal case is rare.

FIG. 11 depicts a more common situation in which qubits 12, 12′ can interact or have interacted as some point in time. An interaction 32 is indicated by the two arrows and may be due to coupling via any relevant field. For typical spinors such as electrons, the field is the electromagnetic field. Interaction 32 under the rules imposed by Maxwell's equations establishes entanglement between qubits 12, 12′ or their states |qb1 [symbol] and |qb2 [symbol] _{z}. Now, Hilbert spaces [symbol] _{qb1}, [symbol] _{qb2} can no longer be considered as isolated. Instead, these spaces now form a larger tensor product space defined as [symbol] _{qb1} [symbol] [symbol] _{qb2}.

In space [symbol] _{qb1} [symbol] [symbol] _{qb2}, qubits 12, 12′ assume joint states expressed as tensor product states |qb1 [symbol] [symbol] |qb2 [symbol] . These states need to be decomposed over a new basis that spans the tensor product space [symbol] _{qb1} [symbol] [symbol] _{qb2}. Most often, the Hilbert space of such bipartite system (two-component or two-part system) can be spanned by building on the orthonormal bases of each one of the Hilbert spaces of the tensor product. In fact, the orthonormal z-basis of qubit 12 and the orthonormal basis of qubit 12′ can form a tensor product and thus provide the new basis we are looking for. This statement is quite general. Thus, if a qubit |qbA [symbol] has a decomposition in orthonormal basis {|j [symbol] _{qbA}} that spans its Hilbert space [symbol] _{qbA}, and if a second qubit |qbB [symbol] finds a decomposition in its orthonormal basis {|k [symbol] _{qbB}} that spans its Hilbert space [symbol] _{qbA}, then any arbitrary pure state |QB [symbol] _{AB} in tensor product space [symbol] _{abA} [symbol] [symbol] _{qbB} can be expanded as:

|QB [symbol] _{AB}=Σ_{j,k}ccⱼₖ|j)_{qbA} [symbol] |k [symbol] _{qbB} Eq. 15

In this equation the joint complex coefficients are the ccⱼₖ. In order to conserve probability, the normalization condition still requires that the sum of their squares or norms equal to one (Σ_{j,k}|ccⱼₖ|²=1; compare also with this fact expressed for a single pure state using slightly different notation in Eq. 2). Given these new tools, it is possible to represent bipartite states that are entangled.

The most common representation of entangled qubits 12, 12′ is explained with the aid of the diagram in FIG. 1J. This figure introduces mixed states and how to establish the degree of entanglement from measuring just one of two entangled qubits. In particular, after the interaction indicated in FIG. 11, entangled qubits 12, 12′ are separated and qubit 12 is sequestered in an unavailable location 34 indicated by a box. This means that qubit 12 is inaccessible to the experimenter. In other words, the experimenter cannot measure the state of qubit 12 even in principle. Meanwhile, after interacting with their now lost qubit 12 counterparts, a number of identical qubits 12′ are available for measurement.

As shown in FIG. 1J, qubits 12′ are measured by an apparatus 22′ that is made of a combination of three copies of apparatus 22 introduced in FIG. 1F. Each of the three copies is oriented to measure along one of the three orthogonal axes X, Y, Z. Thus, an experimenter can make a choice about the measurement to be performed on every qubit 12′. Of course, simultaneous measurements along two orthogonal axes are precluded by the Heisenberg Uncertainty Principle so the experimenter will have to decide which measurement to apply to each qubit 12′.

Now, since qubit 12′ is a subsystem of a larger quantum system, namely of the tensor product of qubits 12 and 12′, then even if the state of the composite system is pure (representable by a ray in tensor product space [symbol] _{qb1} [symbol] [symbol] _{qb2}), the state of the subsystem comprised of qubit 12′ need not be. Indeed, it is not a pure state in most cases, except for situations in which there is no interaction between qubits 12, 12′ their states are actually separable. Therefore, in general, the state of qubit 12′ is a mixed state and is conveniently represented with the aid of the density matrix ρ_{qb2}. The subscript qb2 indicates qubit 12′.

Now, if the state of qubit 12′ is a pure state rather than mixed, then density matrix ρ_{qb2} will be found by the experimenter to be a projection onto the one dimensional state space of that pure state of qubit 12′. For example, if qubit 12′ is simply in the z-up state so that |qb2 [symbol] =|+ [symbol] _{z} and never interacts with qubit 12, then density matrix ρ_{qb2} will be found through experiment to be a simple projection onto basis state |+ [symbol] _{z} of qubit 12′. Hence, for a pure state any density matrix has the property of idempotence (ρ²=ρ) in addition to its property of having unit trace (Tr(ρ)=1).

When the state is not pure, then the density matrix will have several entries and will not be idempotent. Such density matrices indicate incoherent mixtures of states, meaning that the relative phases of the component basis states are experimentally inaccessible. Meanwhile, the expectation value [symbol] O [symbol] of an operator O, whether the state is an incoherent mixture or a pure state, is expressed as:

[symbol]

O [symbol] =Tr(Oρ). Eq. 16

It is convenient to remember that the trace operation is not order dependent. Further, the reader is invited to compare this formula with those applying to unentangled states in Eqs. 10a&10b. Clearly, entanglement destroys the coherence of a superposition of states so that some of the phases in the superposition become inaccessible when we look at qubit 12′ alone. Unfortunately, since we have no access to qubit 12, this state of ignorance is a constraint.

Returning to FIG. 1J, we see that it is convenient to describe the density matrix n ρ_{qb2} in terms of a point P̅ in the Bloch sphere (or rather within Bloch ball), the Pauli matrices σₗ, σ₂, σ₃ (collectively designated as σ̅) and the 2×2 identity matrix I (which is frequently designated as Pauli matrix σ₀). Based on these parameters, the density matrix for qubit 12′ can be described once point P̅ is found in a number of experiments on a series of qubits 12′ as:

ρ( P̅)=½(I+ P̅· σ̅). Eq. 17

For better understanding, point P̅ is shown explicitly in FIG. 1J. Notice that when point P̅ is on the surface of the Bloch sphere, as indicated by the empty circle in FIG. 1J, then the norm of its vector representation will be equal to one. This will signify that qubit 12′ is in a pure state and density matrix ρ_{qb2} is just a projection operator onto that pure state. Otherwise, the state of qubit 12′ is to be construed as progressively more entangled with qubit 12, the closer point P̅ is to the center of the Bloch ball.

For the most entangled singlet state between qubits 12, 12′ (also sometimes called the Einstein Podolsky Rosen (EPR) state) the density matrix is:

$$ρ = \frac{1}{2} I = [ \begin{matrix}1 / 2 & 0 \\ 0 & 1 / 2\end{matrix} ] . \qquad Eq . 18$$

In this state point P̅ is at the center of the Bloch ball and all measurements are equiprobable. In other words, no matter along what direction the experimenter will choose to measure the state of qubit 12′ with apparatus 22′, the likelihood of an up (“yes”) or down (“no”) measurement will be the same (50/50). In fact, this will be true for an arbitrary direction u, since the Pauli matrices are traceless (the diligent reader may wish to convince himself or herself by taking Eq. 16 and substituting the density matrix of the singlet state from Eq. 18 to hence derive [symbol] _{u,qb2} [symbol] =Tr(σ_{u,qb2}ρ_{qb2})=0)

Unfortunately, other than the extremal points confined to the surface of the Bloch ball, a point P̅ within it does not designate a unique density matrix. Indeed, there are many ways to prepare density matrices for any state within the Bloch ball given the convexity of the set of density matrices. In other words, while the preparation of the pure state is always unambiguous there are many ways to obtain a given mixed state. Yet, most states encountered in nature are mixed and, what is more problematic still, most of the time little can be said about the systems with which they may have interacted.

To offset this unhelpful situation, density matrices have many useful characteristics. They do obey a rather simple evolution equation called the von Neumann equation. One can characterize the degree of ignorance about the quantum states with many standard tools such as entropy (e.g., the standard von Neumann Entropy or other metrics) that explicitly include the density matrix. One can also use the Schmidt decomposition in tensor product spaces to obtain a direct measure of entanglement (the Schmidt number). Furthermore, density matrices can be deployed in many techniques such as the Density-Matrix Renormalization Group (DMRG), which is a method that operates on density matrices rather than pure states (see also operations on reduced density matrices). Additionally, density matrices are compatible with a multitude of variational methods (e.g., quantum Monte Carlo models) that are in use today to address practical problems at micro-scales where our knowledge about the underlying states of the system is very limited.

In view of the state of the art in practical applications of quantum mechanical models, the reader is now in a position to understand why practical applications of quantum models are so computationally intensive and challenging. It is these fairly fundamental obstacles that thwart the deployment of quantum mechanical methods in many practical situations. In fact, these and still other new problems having to do with extending the realm of applicability of quantum methods to other realms (e.g., at larger scales) render a systematic study of our reality with quantum models beyond current human capabilities.

### 5. Prior Art Applications of Quantum Theory to Subject States

Since the advent of quantum mechanics, many have realized that some of its non-classical features may better reflect the state of affairs at the human grade of existence. In particular, the fact that state vectors inherently encode incompatible measurement outcomes and the probabilistic nature of measurement do seem quite intuitive upon contemplation. Thus, many of the fathers of quantum mechanics did speculate on the meaning and applicability of quantum mechanics to human existence. Of course, the fact that rampant quantum decoherence above microscopic levels tends to destroy any underlying traces of coherent quantum states was never helpful. Based on the conclusion of the prior section, one can immediately surmise that such extension of quantum mechanical models in a rigorous manner during the early days of quantum mechanics could not even be legitimately contemplated.

Nevertheless, among the more notable early attempts at applying quantum techniques to characterize human states are those of C. G. Jung and Wolfgang Pauli. Although they did not meet with success, their bold move to export quantum formalisms to large scale realms without too much concern for justifying such procedures paved the way others. More recently, the textbook by physicist David Bohm, “Quantum Theory”, Prentice Hall, 1979 ISBN 0-486-65969-0, pp. 169-172 also indicates a motivation for exporting quantum mechanical concepts to applications on human subjects. More specifically, Bohm speculates about employing aspects of the quantum description to characterize human thoughts and feelings.

In a review article published online by J. Summers, “Thought and the Uncertainty Principle”, http://www.jasonsummers.org/thought-and-the-uncertainty-principle/, 2013 the author suggests that a number of close analogies between quantum processes and our inner experience and through processes could be more than mere coincidence. The author shows that this suggestion is in line with certain thoughts on the subject expressed by Niels Bohr, one of the fathers of quantum mechanics. Bohr's suggestion involves the idea that certain key points controlling the mechanism in the brain are so sensitive and delicately balanced that they must be described in an essentially quantum-mechanical way. Still, Summers recognizes that the absence of any experimental data on these issues prevents the establishment of any formal mapping between quantum mechanics and human subject states.

The early attempts at lifting quantum mechanics from their micro-scale realm to describe human states cast new light on the already known problem with standard classical logic, typically expressed by Bayesian models. In particular, it had long been known that Bayesian models are not sufficient or even incompatible with properties observed in human decision-making. The mathematical nature of these properties, which are quite different from Bayesian probabilities, were later investigated in quantum information science by Vedral, V., “Introduction to quantum information science”, New York: Oxford University Press 2006.

Taking the early attempts and more recent related motivations into account, it is perhaps not surprising that an increasing number of authors argue that the basic framework of quantum theory can be somehow extrapolated from the micro-domain to find useful applications in the cognitive domain. Some of the most notable contributions are found in: Aerts, D., Czachor, M., & D'Hooghe, B. (2005), “Do we think and communicate in quantum ways? On the presence of quantum structures in language”, In N. Gontier, J. P. V. Bendegem, & D. Aerts (Eds.), Evolutionary epistemology, language and culture. Studies in language, companion series. Amsterdam: John Benjamins Publishing Company; Atmanspacher, H., RoÅNmer, H., & Walach, H. (2002), “Weak quantum theory: Complementarity and entanglement in physics and beyond”, Foundations of Physics, 32, pp. 379-406.; Blutner, R. (2009), “Concepts and bounded rationality: An application of Niestegge's approach to conditional quantum probabilities”, In Accardi, L. et al. (Eds.), Foundations of probability and physics-5, American institute of physics conference proceedings, New York (pp. 302-310); Busemeyer, J. R., Wang, Z., & Townsend, J. T. (2006), “Quantum dynamics of human decision-making”, Journal of Mathematical Psychology, 50, pp. 220-241; Franco, R. (2007), “Quantum mechanics and rational ignorance”, Arxiv preprint physics/0702163; Khrennikov, A. Y., “Quantum-like formalism for cognitive measurements”, BioSystems, 2003, Vol. 70, pp. 211-233; Pothos, E. M., & Busemeyer, J. R. (2009), “A quantum probability explanation for violations of ‘rational’ decision theory”, Proceedings of the Royal Society B: Biological Sciences, 276. Recently, Gabora, L., Rosch, E., & Aerts, D. (2008), “Toward an ecological theory of concepts”, Ecological Psychology, 20, pp. 84-116 have even demonstrated how this framework can account for the creative, context-sensitive manner in which concepts are used, and they have discussed empirical data supporting their view.

An exciting direction for the application of quantum theory to the modeling of inner states of subjects was provided by the paper of R. Blutner and E. Hochnadel, “Two qubits for C. G. Jung's theory of personality”, Cognitive Systems Research, Elsevier, Vol. 11, 2010, pp. 243-259. The authors propose a formalization of C. G. Jung's theory of personality using a four-dimensional Hilbert space for representation of two qubits. This approach makes a certain assumption about the relationship of the first qubit assigned to psychological functions (Thinking, Feeling, Sensing and iNtuiting) and the second qubit representing the two perspectives (Introversion and Extroversion). The mapping of the psychological functions and perspectives presumes certain relationships between incompatible observables as well as the state of entanglement between the qubits that does not appear to be borne out in practice, as admitted by the authors. Despite this insufficiency, the paper is of great value and marks an important contribution to techniques for mapping problems regarding the behaviors and states of human subjects to qubits using standard tools and models afforded by quantum mechanics.

Thus, attempts at applying quantum mechanics to phenomena involving subjects at macro-levels have been mostly unsuccessful. A main and admitted source of problems lies in the translation of quantum mechanical models to human situations. More precisely, it is not at all clear how to map subject states as well as subject actions or reactions to quantum states. In fact, it is not even clear what is the correct correspondence between subject states, subject reactions and measurements of these quantities, as well as the unitary evolution of these states when not subject to measurement.

Furthermore, many questions about measurement given the issues of decoherence and the formal problems that came into focus at the end of technical sub-section 4 of the present Background description remain difficult to address. Finally, the prior art does not provide for a quantum informed approach to gathering data. Instead, the state of the art for development of predictive personality models based on “big data” collected on the web is ostensibly limited to classical data collection and classification approaches. Some of the most representative descriptions of these are provided by: D. Markvikj et al., “Mining Facebook Data for Predictive Personality Modeling”, Association for the Advancement of Artificial Intelligence, www.aaai.org, 2013; G. Chittaranjan et al., “Who's Who with Big-Five: Analyzing and Classifying Personality Traits with Smartphones”, Idiap Research Institute, 2011, pp. 1-8; B. Verhoeven et al., “Ensemble Methods for Personality Recognition”, CLiPS, University of Antwerp, Association for the Advancement of Artificial Intelligence, Technical Report WS-13-01, www.aaai.org, 2013; M. Komisin et al., “Identifying Personality Types Using Document Classification Methods”, Dept. of Computer Science, Proceedings of the Twenty-Fifth International Florida Artificial Intelligence Research Society Conference, 2012, pp. 232-237.

### OBJECTS AND ADVANTAGES

In view of the shortcomings of the prior art, it is an object of the present invention to provide for predicting probable responses of subjects such as human beings based on mappings of internal states of the subject to quantum states represented by qubits in a non-presumptive manner. More precisely, the mapping to the quantum mechanical representation is to be performed in a fashion that allows for subsequent tuning of the quantum states and their relationship from experience and large amounts of measurement data becoming available to us in the modern connected world.

It is a further object of the invention to provide for a method and apparatus that enable prediction of subject reactions to propositions involving object-subject as well as subject-subject interactions based on the quantum model in a manner that is compatible with big data.

Still other objects and advantages of the invention will become apparent upon reading the detailed specification and reviewing the accompanying drawing figures.

### SUMMARY OF THE INVENTION

The present invention relates to a method and an apparatus for predicting a most probable response of a subject to a proposition that admits of at least two mutually exclusive responses. The apparatus is typically embodied by a computer system. The subject is usually a human being or another sentient being. By mutually exclusive we mean opposite responses, actions or indications such as “yes” and “no”, “high” and “low”, “left” and “right”. These can also be actions that cannot be performed simultaneously, or else opinions and/or positions modulo the proposition that cannot be maintained concurrently. The method is based on deploying a quantum mechanical model of the subject's internal state and of the proposition in terms of quantum mechanical bits or qubits used in quantum information theory.

The method calls for storing measurable indications a, b of a primary internal state of the subject in a memory. Then, an assignment module is used for making a number of crucial assignments.

First, the assignment module assigns the primary internal state of the subject to a first subject qubit |iss1 [symbol] . Subject qubit |iss1 [symbol] is conveniently expressed in a u-basis decomposition into at least two orthogonal subject state eigenvectors |iss1a [symbol] ᵤ, |iss1 [symbol] ᵤ with at least two subject state eigenvalues λₐ, λ_{b}. By the rules of quantum mechanics, the eigenvalues λₐ, λ_{b} are taken to correspond to the measurable indications a, b of the primary internal state of the subject.

Second, the assignment module assigns a response qubit |rsp [symbol] to the subject with respect to the proposition. Response qubit |rsp [symbol] is expressed by a v-basis decomposition into subject response eigenvectors |rspR1 [symbol] ᵥ, |rspR2 [symbol] ᵥ. The eigenvectors have subject response eigenvalues λ₁, λ_{R2} that correspond to the at least two mutually exclusive responses R1, R2 that the subject can exhibit modulo the proposition.

Third, the assignment module assigns a proposition matrix PR to the proposition. Thus, the proposition is translated into a legitimate quantum mechanical operator. To ensure proper operation, proposition matrix PR has the response eigenvectors |rspR1 [symbol] ᵥ, |rspR2 [symbol] ᵥ.

Proper operation is predicated on knowledge of the relation between the first subject qubit |iss1 [symbol] and the response qubit |rsp [symbol] for the purpose of predicting the likelihood of measurable events. Thus, in another step, a statistics module is used to curate an event probability γ. This probability is based on probabilities derived from empirical tests or on initial estimates provided by skilled human curators. Specifically, event probability γ is based on the first subject qubit |iss1 [symbol] , standing in for the subject, confronting the proposition and engaging therewith to yield a proper quantum measurement of the response qubit |rsp [symbol] . Of course, this will not always be the case, and thus event probability γ is typically expected to be less than unity (i.e., the event is less than 100% likely).

In cases where the subject actually confronts the proposition and engages with it to yield a proper quantum measurement, the method and computer system deploy a prediction module to predict the subject's most probable response. The most probable response is obtained directly from the quantum mechanical prescription for the expectation value [symbol] PR [symbol] ᵣₛₚ of the proposition matrix PR. This standard quantum computation is performed by sandwiching the proposition matrix between the bra and ket state vectors expressing response qubit |rsp [symbol] ( [symbol] PR [symbol] ᵣₛₚ= [symbol] rsp|PR|rsp [symbol] ).

In a preferred embodiment the method further calls for the deployment of a network behavior monitoring unit for curating estimated quantum probabilities pₐ, p_{b}. These are the probabilities of observing the primary internal state of the subject yield measurable indications a, b in response to a quantum measurement or an act of observation of the internal state (e.g., by direct inquiry or observing action(s) known to be indicative of the internal state). Since the first subject qubit |iss1 [symbol] is expressed in the chosen u-basis decomposition as |iss1 [symbol] =αₐ|iss1α [symbol] ᵤ+μ_{b}|iss1b [symbol] ᵤ, where αₐ and β_{b} are the complex coefficients characteristic of this spectral decomposition, then the estimated quantum probabilities pₐ, p_{b} can simply be set equal to the complex coefficient norms αₐ*αₐ and β_{b}*β_{b}. In other words, pₐ=αₐ*αₐ and p_{b}=β_{b}*β_{b}.

Similarly, it is preferred that the network behavior monitoring unit curate estimated quantum probabilities p_{R1}, p_{R2} of observing the at least two mutually exclusive responses R1, R2 to the quantum measurement of the response qubit |rsp [symbol] . Since response qubit |rsp [symbol] is expressed in the v-basis decomposition as |rsp [symbol] =α_{R1}|rspR1 [symbol] ᵥ+β_{R2}|rspR2 [symbol] ᵥ, we once again find that α_{R1} and β_{R2} represent the complex coefficients. Therefore, the network behavior monitoring unit sets the estimated quantum probabilities p_{R2}, p_{R2} equal to the complex coefficient norms α*_{R1}α_{R1} and β*_{R2}β_{R2} (or p_{R1}=α*_{R1}α_{R1} and p_{R2}=β*_{R2}β_{R2}).

In some embodiments it is desirable to employ a random event mechanism seeded with the estimated quantum probabilities p_{R1}, p_{R2}. This can be particularly useful when simulating the occurrence of the mutually exclusive responses R1, R2 for the subject. Such simulation can be performed with a suitable simulation engine that may further supply its output to other useful apparatus and as input to secondary applications (e.g., large scale prediction mechanisms). For example, the simulation engine can simulate a string of occurrences of the most probable response for the subject and its output can be connected to the network behavior monitoring unit to provide a sampling of these occurrences. Based on the sampling, the network behavior monitoring unit can refine its curated estimates of any quantum probabilities that it is tracking for the subject or other subjects judged similar to the subject in question.

In the preferred embodiment, it is also important to estimate a basis relationship between the first subject qubit |iss1 [symbol] in the u-basis decomposition and the response qubit |rsp [symbol] in the v-basis decomposition. This estimation function is conveniently assigned to the statistics module. When the estimate of the basis relationship is available the event probability γ can be adjusted. In particular, the statics module can introduce a quantum interaction probability pᵢₙₜ that is based on the basis relationship estimate and can be used to adjust the event probability γ. For example, a basis misalignment can be determined between a u-ray defining the u-basis and a v-ray defining the v-basis. The misalignment can then be used to estimate quantum interaction probability pᵢₙₜ and adjust the event probability γ correspondingly.

In practical applications the event probability γ will need to also be adjusted based on at least one classical probability. A first exemplary classical probability that affect event probability γ is a null response probability pₙᵤₗₗ to the proposition by the subject. An exemplary null response to the proposition is a non-sequitur response or action. Stated differently, the subject's reaction indicates an irrelevance of the proposition with respect to themselves. A second exemplary classical probability bearing on event probability γ is a non-engagement probability pₙₑ in which the subject, despite being presented with the proposition, does not engage with it. The statistics module should adjust event probability γ by these and any other relevant classical probabilities.

In certain applications the nature of the proposition may change such that the at least two mutually exclusive responses are no longer those in the v-basis. For example, the proposition posed to the subject is to buy tickets for a movie now and the two mutually exclusive responses in the v-basis are “buy ticket” and “don't buy ticket”. Due to a change in external conditions the movie can't be shown until an unspecified screening time. However, the proposition to the subject to “buy ticket” and “don't buy ticket” for this movie remains on the table. Clearly, this situation is different, although the two mutually exclusive responses are identical, namely “buy ticket” and “don't buy ticket”.

Under such conditions it is necessary to perform a change in basis to translate or migrate response qubit |rsp [symbol] from the v-basis decomposition to the new w-basis decomposition appropriate to the altered proposition. The basis change is preferably executed by the assignment module. The prediction module can predict a most probable response of the subject modulo the altered proposition based on the w-basis decomposition of the response qubit |rsp [symbol] . Of course, the amended proposition has to now be represented by a different proposition matrix with different eigenvectors. These can be gleaned from the rules of quantum mechanics.

In some embodiments of the method the quantum mechanical Hilbert space is introduced explicitly. Namely, the first subject qubit |iss1 [symbol] is placed in a first subject space [symbol] ᵢₛₛ₁. The response qubit |rsp [symbol] is placed in a response space [symbol] ᵣₛₚ. Then, the space relationship between the first subject space [symbol] ᵢₛₛ₁ and the response space [symbol] ᵣₛₚ are determined. Once obtained, the event probability γ is adjusted based on this space relationship. Depending on the embodiment, adjustment due to space relationship can be considered to contribute to quantum interaction probability pᵢₙₜ.

In some embodiments the state of response qubit |rsp [symbol] is not considered pure. Thus, the quantum expectation value [symbol] PR [symbol] ᵣₛₚ will be computed under the assumption of some interaction between the response qubit |rsp [symbol] with an environment. Of course, the possibility of interaction can be limited by ensuring that the subject is confronted by the proposition immediately upon declaring their internal state. This will limit decoherence through interaction with the environment. Still, entanglement with other subjects and their internal states cannot be excluded. These conditions will force us to resort to a density matrix ρᵣₛₚ for describing response qubit |rsp [symbol] and the quantum expectation value will be represented by Tr(PRᵣₛₚρᵣₛₚ) where Tr stands for the trace of the matrix product.

In contrast to response qubit |rsp [symbol] , the first subject qubit |iss1 [symbol] will be taken as pure in most cases. This pure state can be adjusted by a perturbation to account for various error sources. Furthermore, it is advantageous to select the primary internal state from among internal states that are commonly recognized as very stable and reliable over long periods of time. For example, the primary internal state can be a Jungian type, a Big 5 type, a personality trait, a preference, an attribute or a proclivity, and even an addiction or a strongly held belief. The primary internal state can be inferred from a documented online presence, including network behaviors of the subject. Alternatively, it can be determined from any suitable type of self-report of the subject about their primary internal state.

In some embodiments the assignment module supports the assignment of a secondary internal state of the subject to a second subject qubit |iss2 [symbol] . Such assignment should be followed by testing for quantum entanglement between the first subject qubit |iss1 [symbol] and the second subject qubit |iss2 [symbol] to better determine the usefulness of the combination. Specifically, the combination should be useful in making predictions about responses of the subject modulo propositions. Otherwise the dramatic increase in complexity of the model that deploys two potentially entangled qubits to describe the subject may be counterproductive.

The computer system implementing the quantum model can be local or distributed. In fact, given the large quantities of data involved, it is preferable that the computer system be implemented in a cluster setting where independent nodes may assume the roles of the different modules. Furthermore, the computer system should preferably include or be connected to a simulation engine for performing simulations based at least in part on the most probable response predicted by the prediction module. The network behavior monitoring unit, which will typically be a remote unit or even part of a social network hosting infrastructure, should be connected to the simulation engine. It will thus be able to receive a sampling of occurrences of the most probable response and perform some tuning based on this data.

The present invention, including the preferred embodiment, will now be described in detail in the below detailed description with reference to the attached drawing figures.

### BRIEF DESCRIPTION OF THE DRAWING FIGURES

FIG. 1A (Prior Art) is a diagram illustrating the basic aspects of a quantum bit or qubit.

FIG. 1B (Prior Art) is a diagram illustrating the set of orthogonal basis vectors in the complex plane of the qubit shown in FIG. 1A.

FIG. 1C (Prior Art) is a diagram illustrating the qubit of FIG. 1A in more detail and the three Pauli matrices associated with measurements.

FIG. 1D (Prior Art) is a diagram illustrating the polar representation of the qubit of FIG. 1A.

FIG. 1E (Prior Art) is a diagram illustrating the plane orthogonal to a state vector in an eigenstate along the u-axis (indicated by unit vector û).

FIG. 1F (Prior Art) is a diagram illustrating a simple measuring apparatus for measuring two-state quantum systems such as electron spins (spinors).

FIG. 1G (Prior Art) is a diagram illustrating the fundamental limitations to finding the state vector of an identically prepared ensemble of spinors with single-axis measurements.

FIG. 1H (Prior Art) is a diagram showing two independent, unentangled qubits.

FIG. 1I (Prior Art) is a diagram showing two entangled qubits.

FIG. 1J (Prior Art) is a diagram illustrating the principles of measurement in the presence of entanglement based on the most entangled singlet state and introduces the density matrix.

FIG. 2 is a diagram illustrating the most important parts and modules of a computer system in a basic configuration.

FIG. 3A is a diagram showing the type of proposition that can be processed in accordance with the invention.

FIG. 3B is a diagram illustrating the details of the assignment of the subject's primary internal state to a subject qubit.

FIG. 3C is a diagram illustrating the details of the assignment of the subject's response modulo a proposition.

FIG. 3D is a diagram showing the details of the assignment of the subject's response modulo a proposition that re-tests the subject's primary internal state.

FIG. 3E is a diagram illustrating the details of the construction of the requisite proposition matrix to obtain a measurement of the subject's response.

FIG. 4 is a diagram of an ideal situation for the application of the computer system and for calibration of the quantum representation.

FIG. 5 is a diagram illustrating in more detail the measurement of the response qubit under the calibration or re-test condition shown in FIG. 4.

FIG. 6 is a diagram showing exploration of the qubit space using commutator algebra for the purpose of discovering a measure of misalignment between the u and v bases.

FIG. 7 is a diagram showing how to explore incompatible contexts modulo the same underlying proposition.

FIG. 8 is a diagram showing incompatible context modulo the same underlying proposition involving another subject.

FIG. 9 is a diagram illustrating how temporal evolution of a qubit results in error.

FIG. 10A is a diagram illustrating how to account for error due to temporal evolution.

FIG. 10B is a diagram illustrating how to account for error due to misreports and other bounded sources of inaccuracy in qubits by perturbation.

FIGS. 11A-D is a sequence of diagrams illustrating an advantageous application of the invention in conducting polling activities.

FIG. 12A is a diagram illustrating a fundamental source of error due to qubit interaction with the environment.

FIG. 12B is a diagram showing how the adoption of the density matrix formalism to account for decoherence and interaction with the environment can be used in the present invention.

### DETAILED DESCRIPTION

The drawing figures and the following description relate to preferred embodiments of the present invention by way of illustration only. It should be noted that from the following discussion, alternative embodiments of the methods and systems disclosed herein will be readily recognized as viable options that may be employed without straying from the principles of the claimed invention. Likewise, the figures depict embodiments of the present invention for purposes of illustration only. One skilled in the art will readily recognize from the following description that alternative embodiments of the methods and systems illustrated herein may be employed without departing from the principles of the invention described herein.

Prior to describing the embodiments of the apparatus and methods of the present invention it is important to articulate what this invention is not attempting to imply or teach. This invention does not take any ideological positions on the nature of the human mind, nor does it attempt to answer any philosophical questions related to epistemology or ontology. The instant invention does not attempt, nor does it presume to be able to follow up on the suggestions of Niels Bohr and actually find which particular processes or mechanisms in the brain need or should be modeled with the tools of quantum mechanics. This work is also not a formalization of the theory of personality based on a correspondent qubit representation. Such formalization may someday follow, but would require a full formal motivation of the transition from Bayesian probability models to quantum mechanical ones. Formal arguments would also require a justification of the mapping between non-classical portions of human emotional and thought spaces/processes and their quantum representation. The latter would include a description of the correspondent Hilbert space, including a proper basis, support, rules for unitary evolution, formal commutation and anti-commutation relations between observables as well as explanation of which aspects are subject to entanglement with each other and the environment (decoherence) and on what time scales (decoherence time).

Instead, the present invention takes a highly data-driven approach to modeling subject internal states using pragmatic qubit assignments. The availability of “big data” that documents the online life, and in particular the online (as well as real-life) responses of subjects to various propositions including simple “yes/no” type questions, has made extremely large amounts of subject data ubiquitous. Given that quantum mechanical tests require large numbers of identically or at least similarly prepared states to examine in order to ascertain any quantum effects, this practical development permits one to apply the tools of quantum mechanics to uncover such quantum aspects of subject behaviors. Specifically, it permits to set up a quantum mechanical model of internal states and test for signs of quantum mechanical relationships in responses to simple propositions that have at least two mutually exclusive responses. Thus, rather than postulating any a priori relationships between different internal states, e.g., the Jungian categories, we only assume that the self-reported states are reasonably pure at the time that the test was taken, that they suffer relatively limited perturbation and that they do not evolve quickly enough over time-frames of measurement(s) (long decoherence time).

No a priori relationship between different qubits representing internal states is presumed. Thus, the assignment of qubits in the present invention is performed in the most agnostic manner possible. Prior to testing for any complicated relationships including entanglement, just one of the internal states of a given subject, namely a primary internal state is assigned to just one subject qubit. The relationship between the chosen primary internal state and the response to the relevant proposition is then tested. Curation of relevant metrics is performed to aid in the process of discovering quantum mechanical relationships in the data. The curation step preferably includes a final review by human experts that may have direct experience of relevant primary internal state as well as well as experience in being confronted by the proposition under investigation.

### Basic Computer System, Method Steps and Qubit Assignments

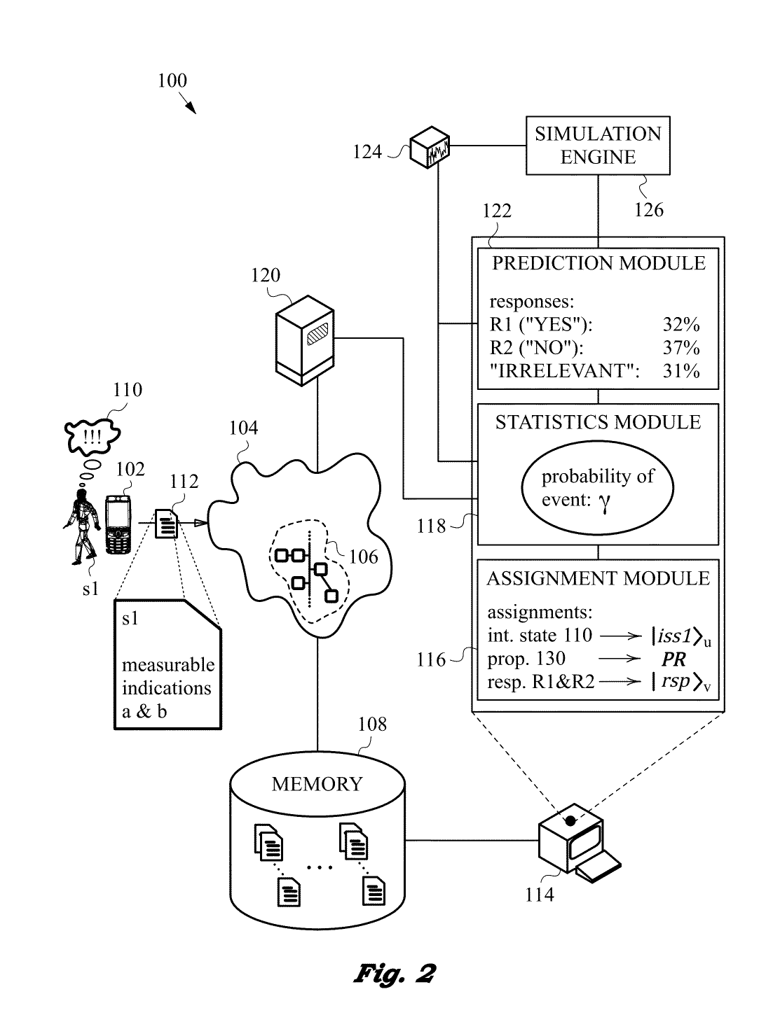

The main parts and modules of an apparatus embodied by a computer system 100 designed for predicting responses of a subject s1 modulo a proposition involving an object or another subject (including the subject themselves) are illustrated in the diagram of FIG. 2. Subject s1 is a human being selected here from a group of many such subjects that are not expressly shown. In principle, subject s1 could be a sentient being other than a human, e.g., an animal. However, the efficacy in applying the methods of invention will usually be highest when dealing with human subjects.

Subject s1 has a networked device 102, here embodied by a smartphone, to enable him or her to communicate data about them in a way that can be captured and processed. In this embodiment, smartphone 102 is connected to a network 104 that is highly efficient at capturing, classifying, sorting, storing and making the data available. Thus, although subject s1 could be known from their actions observed and reported in regular daily life, in the present case subject s1 is known from their online communications as documented on network 104.

Network 104 can be the Internet, the World Wide Web or any other wide area or local network that is private or public. Furthermore, subject s1 may be a member of a social group 106 that is hosted on network 104. Social group or social network 106 can include any online community such as Facebook, LinkedIn, Google+, MySpace, Instagram, Tumblr, YouTube or any number of other groups or networks in which subject s1 may be active. Additionally, documented online presence of subject s1 includes relationships with product sites such as Amazon.com, Walmart.com, bestbuy.com as well as affinity groups such as Groupon.com and even with shopping sites specialized by media type and purchasing behavior, such as Netflix.com, iTunes, Pandora and Spotify. Relationships from network 106 that is erected around an explicit social graph or friend/follower model are preferred due to the richness of relationship data that augments documented online presence of subject s1.

Computer system 100 has a memory 108 for storing measurable indications a, b of a primary internal state 110 of subject s1 as well as other subjects not explicitly shown in FIG. 2. In the present embodiment, measurable indications a, b are captured in a data file 112 that is generated by subject s1. Conveniently, following socially acceptable standards, data file 112 is shared by subject s1 with network 104 by transmission via smartphone 102. Network 104 channels data file 112 to memory 108 for archiving. Memory 108 can be a mass storage device for archiving all activities on network 104, or a dedicated device of smaller capacity for tracking just the activities of subjects of interest.

It should be pointed out that in principle any method or manner of obtaining measurable indications a, b is acceptable, as long as they can be reliably stored and retrieved from memory 108. The advantage of the modern connected world is that large quantities of self-reported measurable indications a, b of primary internal state 110 are generated by subject s1 and shared, frequently in real time, with network 104. This represents a massive improvement in terms of data collection time, data freshness and, of course, sheer quantity of reported data.

Computer system 100 is equipped with a separate computer or processor 114 for making a number of crucial assignments based on measurable indications a, b contained in data file 112. For this reason, computer 114 is either connected to network 104 directly, or, preferably, it is connected to memory 108 from where it can retrieve data file 112 at its own convenience. It is noted that the quantum models underlying the present invention will perform best when large amounts of data are available. Therefore, it is preferred that computer 114 leave the task of storing and organizing data files 112 to memory 108, rather than deploying its own resources for this job.

Computer 114 has an assignment module 116 that is specifically designed for the task of making certain assignments based on quantum representations adopted by the invention. Module 116 is indicated as residing in computer 114, but in many embodiments it can be located in a separate processing unit altogether. This is mainly due to the nature of the assignments being made and the processing required. More precisely, assignments related to quantum mechanical representations are very computationally intensive for central processing units (CPUs) of regular computers. In many cases, units with graphic processing units (GPUs) are more suitable for implementing the linear algebra instructions associated with assignments dictated by the quantum model that assignment module 116 has to effectuate.

Computer 114 also has a statistics module 118 that is specifically designed for curating an event probability γ associated with subject s1. Since initial event probability γ will typically be derived from large numbers of statistical data about subject s1 from network 104 and/or adjusted by a skilled human curator, module 118 may in certain embodiments be a separate unit that is not even geographically collocated with computer 114. In many cases, statistics modules 118 that perform classical modeling of subject behaviors can be adapted for this purpose.

The main motivation behind this choice is the nature of event probability γ. Probability γ typically includes some “classical” probabilities for subject s1 engaging or not engaging with certain offers and/or choosing to disregard offers despite being susceptible to steering to the relevant site and presentation of the offer (the “hover but no click” syndrome). Such data, usually complied by online marketing engines and other sources is very useful for the methods of the present invention. Hence, in a preferred embodiment, statistics module 118 is integrated with a classical online marketing engines and database.

Preferably, computer system 100 has a network behavior monitoring unit 120. Unit 120 monitors and tracks network behaviors and communications of subjects including subject s1 that are on network 104 or even members of specific social groups 106. Thus, unit 120 can process data from data files of many subjects connected to network 104 and discern large-scale patterns. Advantageously, statistics module 118 is therefore connected to network behavior monitoring unit 120 to obtain from it information that can aid it in maintaining the best estimate of event probability γ.

Computer system 100 also has a prediction module 122 for predicting a most probable response of subject s1 modulo a proposition that has at least two mutually exclusive responses labeled here as R1, R2. In practice, responses R1, R2 can be, for example, “YES” and “NO”. In some cases a null response or non-response generally indicated as “IRRELEVANT” can also be predicted.

Prediction module 122 can reside in computer 114 or be a separate unit. For reasons analogous to those affecting assignment module 116, prediction module 122 can benefit from being implemented in a GPU with associated hardware well known to those skilled in the art. Irrespective of its hardware implementation, module 122 is connected to both assignment module 116 and statistics module 118 in order to be able to generate its predictions.

Computer system 100 has a random event mechanism 124 connected to both statistics module 118 and prediction module 122. From those modules, random event mechanism can be seeded with certain estimated quantum probabilities as well as other statistical information, including classical probabilities that affect event probability γ to randomly generate events in accordance with those probabilities and statistical information. Advantageously, random event mechanism 124 is further connected to a simulation engine 126 to supply it with input data. In the present embodiment simulation engine 126 is also connected to prediction module 122 to be properly initialized in advance of any simulation runs. The output of simulation engine 126 can be delivered to other useful apparatus where it can serve as input to secondary applications such as large-scale prediction mechanisms for social or commercial purposes or to market analysis tools and online sales engines. Furthermore, simulation engine 126 is also connected to network behavior monitoring unit 120 in this embodiment in order to aid unit 120 in its task in discerning patterns affecting subject s1 or other subjects based on data passing through network 104.

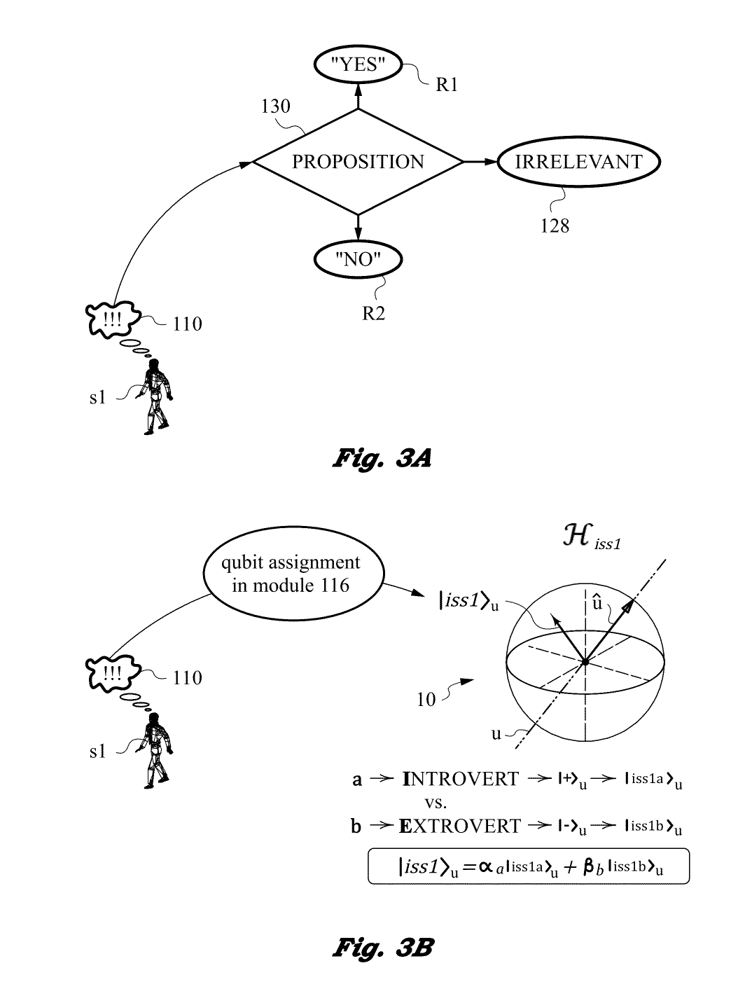

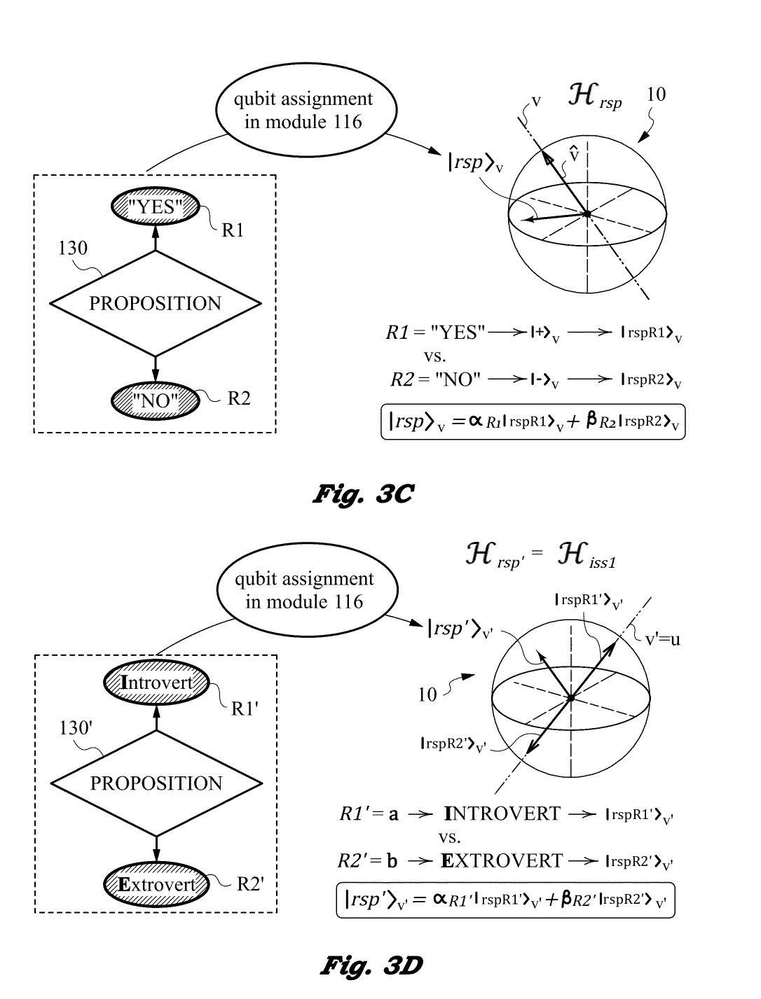

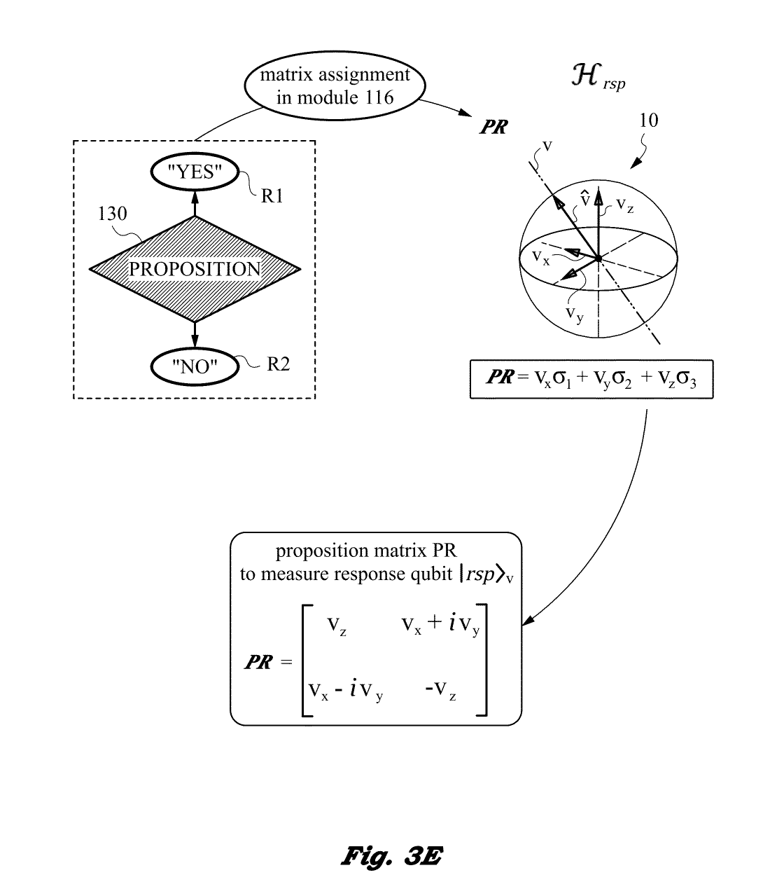

We will now examine the operation of computer system 100 based initially on the diagrams in FIG. 2 and FIGS. 3A-E. First, we consider data file 112 and the measurable indications a, b it contains. It will be assumed that subject s1 and data file 112 are representative of many subjects and their corresponding data files. However, using a single subject s1 and their data file 112 is useful for pedagogical reasons.

Computer 114 typically procures data file 112 from memory 108 after it has been time-stamped and archived there. In this way, computer 114 is not tasked with monitoring online activities of various subjects, including subject s1, which is the purview of network behavior monitoring unit 120.

Data file 112 either contains actual values of measurable indications a, b or information from which measurable indications a, b can be derived or inferred. In the easier case, subject s1 has explicitly provided measurable indications a, b through unambiguous self-reports, answers to direct questions, responses to questionnaires, results from tests, or through some other format of conscious or even unconscious self-reports. To elucidate the latter, subject s1 may provide a chronological stream of data in multiple files 112 including postings on social network 106 (e.g., Facebook): 5 posts of “depressed and can't get out of bed” in one 24 hour period.

For two opposite measurable indications such as a standing for “exuberant” and b standing for “depressed”, the stream of files 112 with postings can be used to infer the measurable indication. Namely, the measurable indication may be b, or “depressed”. Of course, the occurrence of these particular postings should be taken in conjunction with postings that lead to inference of measurable indication a, or “exuberant”. An addition and analysis of the postings may yield the following measurable indications: a=“exuberant”—10% and b=“depressed”—90%.

In fact, in the preferred mode of operation, network behavior monitoring unit 120 reviews stream of data files 112 from subject s1 self-reporting on social network 106 without involving computer 114. Unit 120 by itself determines the occurrence of measurable indications a, b. It can then attach metadata to files 112 stored in memory 108 or otherwise communicate to computer 114 estimated probabilities of obtaining measurable indication a or b. In other words, computer 114 can obtain processed data files 112 indicating the probability of measuring indication a or b if one were to confront subject s1 with a proposition in which the subject is themselves and the question has two mutually exclusive responses a or b that cannot both be true at the same time.

In effect, operating in this mode network behavior monitoring unit 120 curates what we will consider herein to be estimated quantum probabilities pₐ, p_{b}. These are the probabilities of observing the primary internal state of subject s1 yield measurable indications a, b in response to a quantum measurement or an act of observation of the internal state (e.g., by direct inquiry or observing action(s) known to be indicative of the internal state). Clearly, a human expert curator or other agent informed about the human meaning of the posts provided by subject s1 should be involved in initially setting the parameters on unit 120 to ensure proper derivation of estimated quantum probabilities pₐ, p_{b}. Appropriate human experts may include psychiatrists, psychologists, counselors and social workers with relevant experience.

In simpler cases, measurable indications a, b are provided in the form of unambiguous data in file 112 and inference is not required. Under these conditions the use of unit 120 to curate estimated quantum probabilities pₐ, p_{b} is superfluous. Unambiguous data can be represented by direct answers or honest self-reports of measurable indications a, b by subject s1. Alternatively, such data can present as network behaviors of unambiguous meaning, reported real life behaviors as well as strongly held opinions, beliefs or mores. Since relatively pure quantum states are presumed for internal subject states, it is important that self-reports be unaffected by 3^{rd} parties and untainted by processing that involves speculative assignments going beyond curation of estimated quantum probabilities pₐ, p_{b}.

In some embodiments computer 114 may itself be connected to network 104 such that it has access to documented online presence of subject s1 in real time. Computer 114 can then monitor the state and online actions of subject s1 without having to rely on archived data from memory 108. Of course, when computer 114 is a typical local device, this may only be practicable for tracking a few very specific subjects or when tracking subjects that are members of a relatively small social group 106 or other small subgroups of subjects of known affiliations.

Primary internal state 110 of subject s1 should be selected from among the group of internal human states that have predictive value modulo a certain proposition that is to be presented to subject 100. The predictive value of primary internal state 110 with respect to the proposition should be assessed beforehand. For example, it can be determined from human experience or even informed speculation gathered by persons familiar with human behaviors. Such persons may include psychiatrists, psychologists, counselors and social workers with relevant education and experience.

In general, the group of internal human states from which primary internal state 110 is chosen can include a Jungian type or one of the Myers Briggs diads: (Introvert vs. Extrovert); (Sensing vs. iNtuiting); (Thinking vs. Feeling); (Perceiving vs. Judging). It can also be a Big 5 state that overlaps with some of the above and also isolates the following states: (Neuroticism, Agreeableness, Conscientiousness, Openness to Experience). Other useful sources of internal subject states are found in the California Psychological Inventory (CPI), Basic Personality Inventory (BPI), and any aspects of core self-evaluations and standardized tests deploying numerous and varied models of human subject internal states. Still other predictive internal human states include common personality traits, e.g., clean, outspoken, didactic, pedantic, flippant, ornery, self-aggrandizing, self-effacing, etc. Yet other categorization of internal states stresses preferences, attributes and proclivities. In fact, even esoteric traits may be useful internal human states in the context of the present invention, as long as they offer some predictive value modulo the proposition.

We now turn to the diagram in FIG. 3A to gain an appreciation for the type of proposition that qualifies in the sense of the present invention and is thus fit for processing by computer system 100. FIG. 3A indicates such a proposition 130 abstractly along with a choice between at least two mutually exclusive responses R1, R2 it presents to subject s1. In the present example, proposition 130 has two of the most typical opposite responses or indications expressed by a “yes” or first response R1 and an opposite “no” or second response R2. In general, mutually exclusive responses R1, R2 can also opposites such as “high” and “low”, “left” and “right”, “buy” and “sell”, “near” and “far”, and so on. Proposition 130 may also evoke actions or feelings that cannot be manifested simultaneously, such as liking and disliking the same item at the same time, or performing and not performing some physical action, such as buying and not buying an item at the same time. Frequently, situations in which two or more mutually exclusive responses are considered to simultaneously exist lead to nonsensical or paradoxical conclusions. Thus, in a more general sense mutually exclusive responses in the sense of the invention are such that the postulation of their contemporaneous existence would lead to logical inconsistencies and/or disagreements with fact.

In addition to the at least two mutually exclusive responses R1, R2 the model adopted herein presumes the possibility of a null response 128. Null response 128 expresses an irrelevance of proposition 130 to subject s1 after his or her engagement with it or exposure thereto. In other words, null response 128 indicates a failure of engagement of subject s1 with proposition 130. Null response 130 is assigned a classical null response probability pₙᵤₗₗ. As already noted above, this probability does affect event probability γ monitored by statistics module 118.

An exemplary null response 128 to proposition 130 is a non-sequitur response or action. Stated differently, the subject's reaction, action or inaction indicates an irrelevance of proposition 130 with respect to themselves. The irrelevance may be attributable to any number of reasons including inattention, boredom, forgetfulness, deliberate disengagement and a host of other factors. Experienced online marketers sometimes refer to such situations in their jargon as “hovering and not clicking” by intended leads that have been steered to the intended advertising content but fail to click on any offers. Whenever after exposure to proposition 114 subject s1 reacts in an unanticipated way, no legitimate response can be obtained modulo proposition 130 and the simulation has to take these “non-results” into account with classical null response probability pₙᵤₗₗ.

We now turn to FIG. 3B to learn about the quantum representation of primary internal state 110 of subject s1 produced by assignment module 116. It is important that the assignment of qubits to primary internal state as well as to the reaction of subject s1 modulo proposition 130 be performed in a manner that attempts to avoid anticipating any quantum relationships. In the present case, primary internal state 110 of subject s1 has been selected to be the classic Introvert/Extrovert diad. Measurable indications a, b of this primary internal state 110 are: a→Introvert action or response, b→Extrovert action or response. To further simplify matters, it will be assumed in this example, that subject s1 honestly self-reported by filling out an online personality inventory test. The test was a standard approved on-line personality test sanctioned by human expert curators. Subject s1 answered the questions without deceptive intent, without falling prey to persuasions from 3^{rd} parties and without discussions with friends. Subject s1 then shared it on network 104 from their smartphone in the form of file 112 (see FIG. 2), which was processed and sent to archives in memory 108 by network monitoring unit 120.

Upon receipt of file 112 from memory 108, assignment module 116 assigns primary internal state 110 of subject s1 to a first subject qubit |iss1 [symbol] . First subject qubit |iss1 [symbol] is placed in a first subject space [symbol] ᵢₛₛ₁, which is a Hilbert space according to the conventions of quantum mechanics. For visualization purposes, first subject qubit |iss1 [symbol] is shown on Bloch sphere 10 in the representation already reviewed in the background section. Subject qubit |iss1 [symbol] is conveniently expressed in a u-basis decomposition into two orthogonal subject state eigenvectors |iss1a [symbol] ᵤ, |iss1b [symbol] ᵤ with two corresponding subject state eigenvalues λₐ, λ_{b}. By the rules of quantum mechanics, the eigenvalues λₐ, λ_{b} are taken to stand for measurable indications a, b, that are mapped to specific measurable indications of Introvert, Extrovert of primary internal state 110 of subject s1.

At this juncture it should be remarked, that we are using the two-level system because, despite its simplicity, it contains all of the important features of quantum mechanical models. However, this is not to be interpreted as limiting the applicability of the apparatus and methods of invention to two-state systems. In fact, if the human state space is determined to require representation in higher dimensional Hilbert spaces, then correspondent qubits based on three-, four- or still higher level systems can be recruited. These types of system are available and well understood by skilled artisans practiced in the art of quantum mechanical modeling.

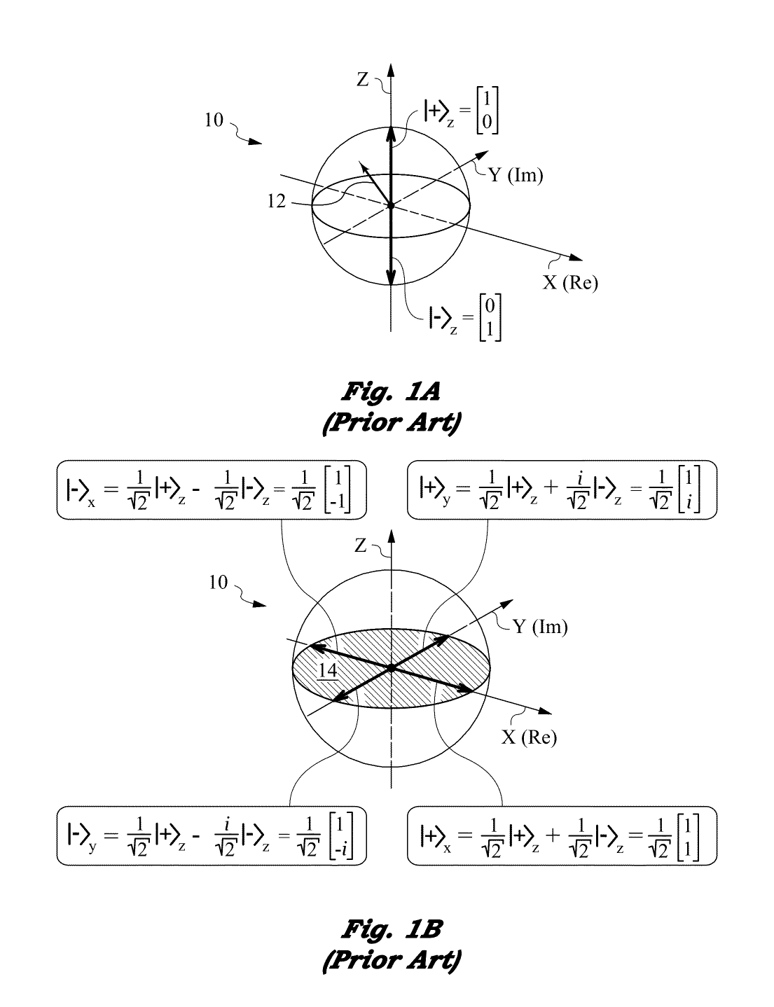

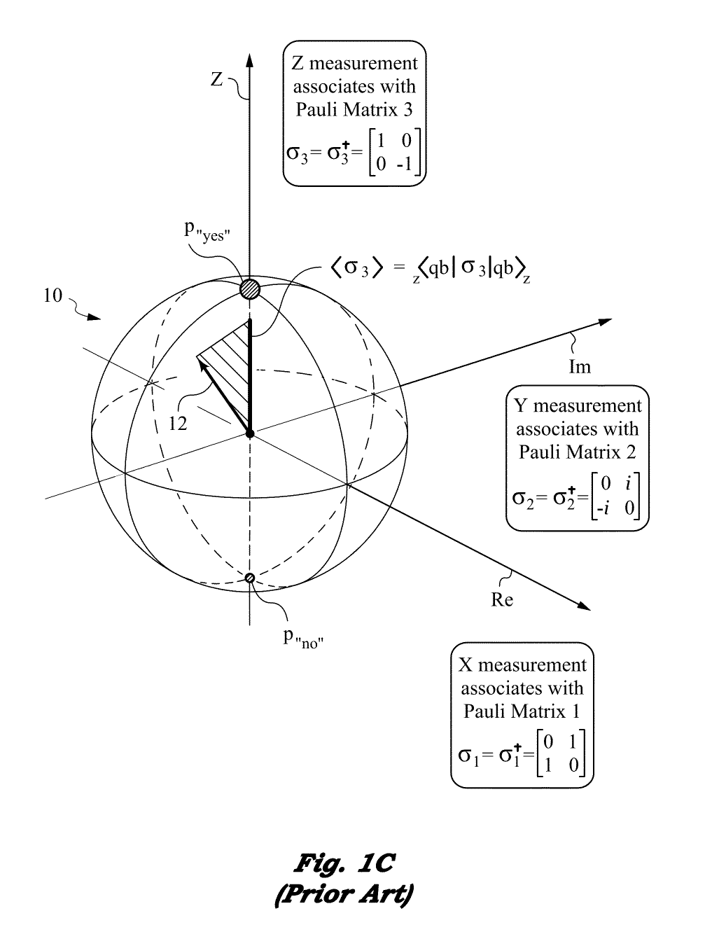

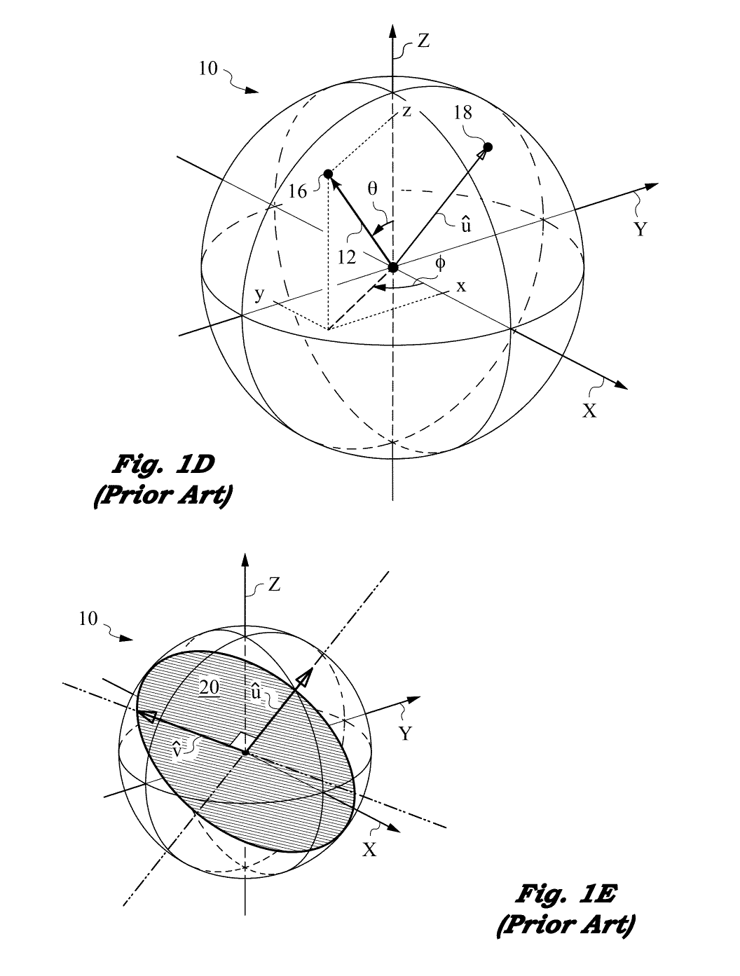

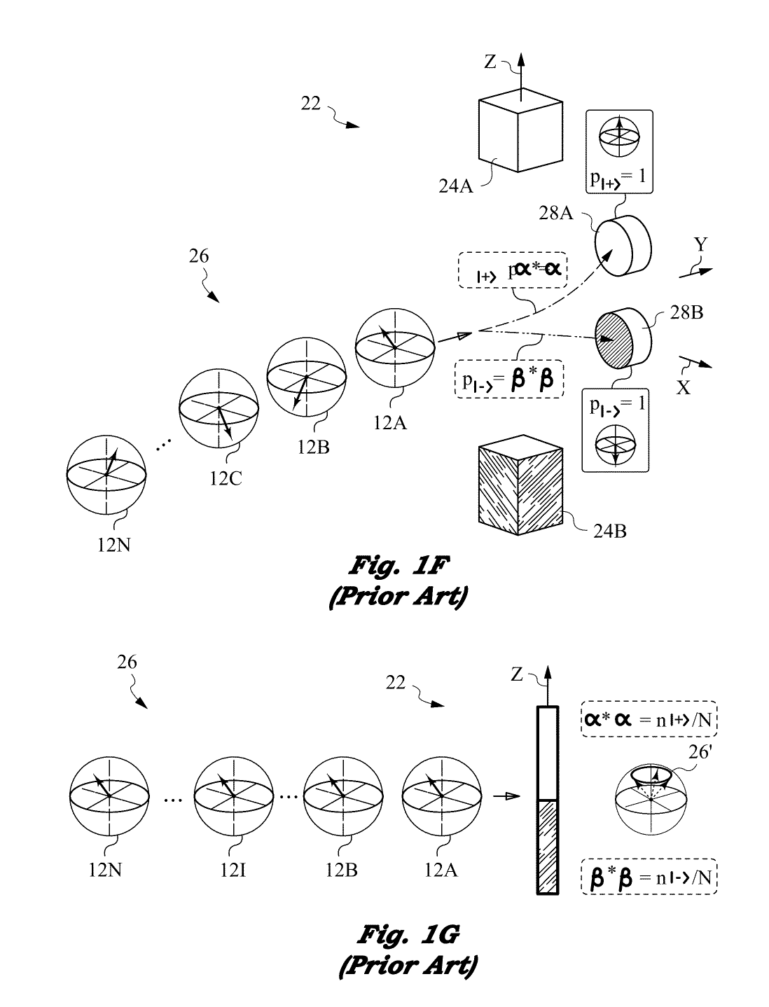

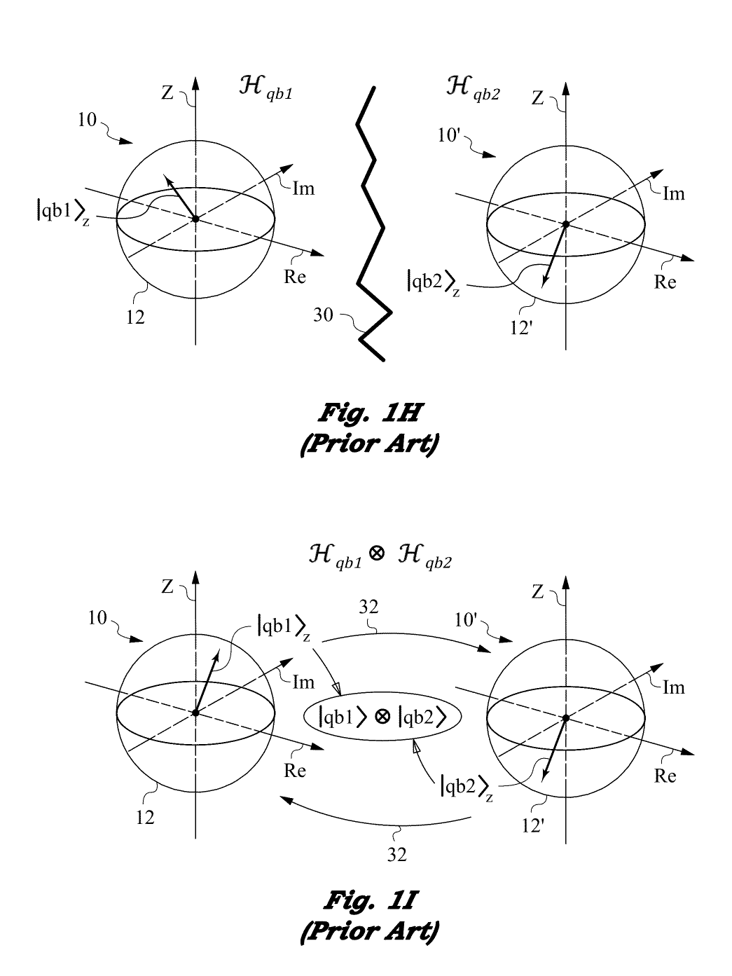

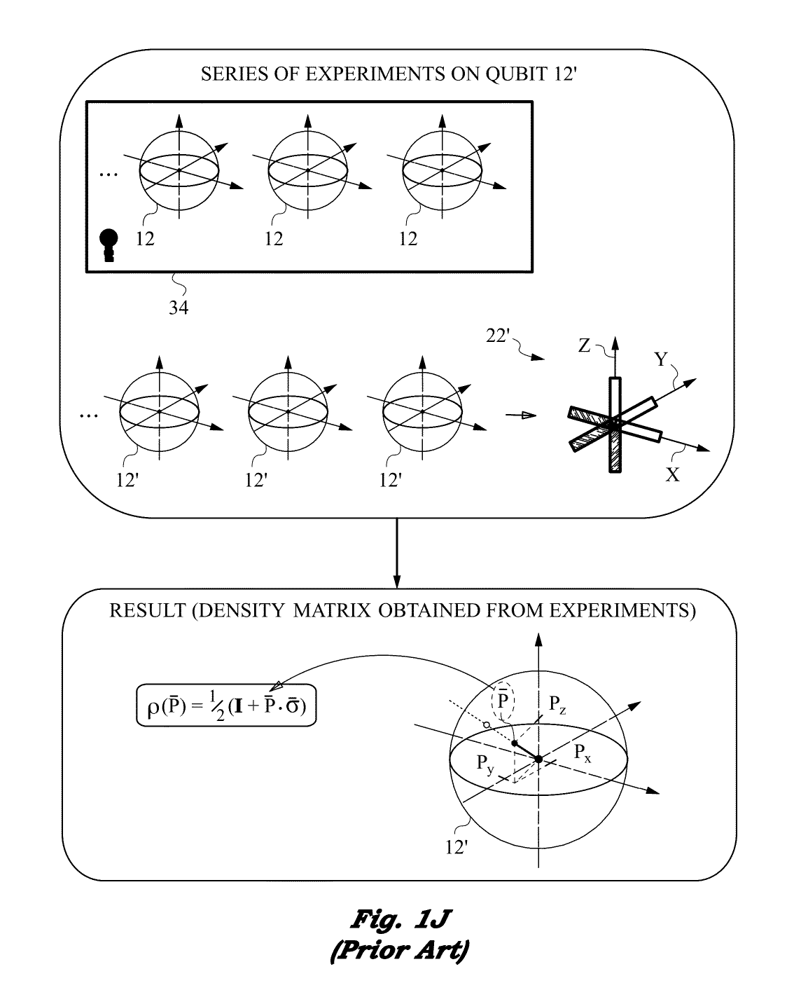

In our present practice, this means that a dyadic internal state 110, such as (Introvert vs. Extrovert) is mapped to the mutually exclusive eigenvectors of spin-up and spin-down, or the state vectors |+ [symbol] ᵤ and |− [symbol] ᵤ in the u-basis as defined by unit vector u in FIG. 1E. Here, Introvert is mapped to eigenvector |+ [symbol] ᵤ, while Extrovert is mapped to eigenvector |− [symbol] ᵤ. To the extent that Bloch sphere 10 is used for representing qubit assignments and other aspects of the invention including “unit vectors”, the reader is again reminded that it serves for the purposes of better visualization (recall the limitations of quantum bit representations in real 3-dimensional space discussed in the background section).

The Bloch-sphere assisted representation of the assignment of subject qubit |iss1 [symbol] , in the u-basis is shown in detail in FIG. 3B. Specifically, subject qubit |iss1 [symbol] is visualized in Bloch sphere 10 and its decomposition over the eigenvector states |+ [symbol] ᵤ and |− [symbol] ᵤ is also indicated. The decomposition is similar to the decomposition of any qubit (see Eq. 7), but to properly reflect the fact that we are dealing with subject qubit |iss1 [symbol] corresponding to internal subject state of subject s1 the naming convention of the eigenvectors is changed to:

|iss1 [symbol] =αₐ|iss1a [symbol] ᵤ+β_{b}|iss1b [symbol] ᵤ Eq. 19a

In adherence to the quantum mechanical model, the two subject state vectors |iss1a [symbol] ᵤ, |iss1b [symbol] ᵤ are accepted into the model along with their two corresponding subject state eigenvalues λₐ, λ_{b}. Given our underlying spinor description of subject qubit |iss1 [symbol] ₂, the eigenvalues are 1 and −1 (or ½ and −½). Differently put, eigenvalue λₐ=1 associates with Introvert internal state |iss1a [symbol] ᵤ— Meanwhile, eigenvalue λ_{b}=−1 associates with Extrovert internal state |iss1b [symbol] ᵤ. Since measurable indications of Introvert and Extrovert do not actually correspond to spin-up along û (1) and spin-down along û (−1) for human subject s1, we instead map them to measurable indications a, b of primary internal state 110, as indicated in FIG. 3B.

For internal state expressed by subject qubit |iss1 [symbol] ᵤ, indications a, b correspond to “Introvert action or response” and “Extrovert action or response”. This somewhat fine point was initially stated above using arrows: a→Introvert action or response, b→Extrovert action or response. The reason for not simply equating indications a, b with states Introvert, Extrovert is because indications are mapped to eigenvalues. These are the physically observable actions or responses subject s1 exhibits. However, in the quantum picture or reality, these are not to be confused with the internal states. The latter are assigned to unobservable quantum mechanical state vectors in the spectral decomposition of subject qubit |iss1 [symbol] ᵤ; i.e., subject state vectors |iss1a [symbol] ᵤ, |iss1b [symbol] ᵤ.

Under a test situation that unambiguously distinguishes between introvert response and extrovert response, indication a corresponds unambiguously, e.g., as defined by social norms and conventions, to the response of an extroverted person. This also means that at the time indication a was measured, the internal space of subject s1 was “collapsed” to subject state vector |iss1a [symbol] ₐ. Meanwhile, under the same test situation that unambiguously distinguishes between introvert response and extrovert response, indication b corresponds clearly to the response of an introverted person. In pursuing the explanation suggested by quantum mechanics, this means that at the time indication b was measured, the internal space or awareness of subject s1 was “collapsed” to subject state vector |iss1b [symbol] ₂. A practical example test may involve a social gathering in which an extrovert would be found greeting people, while an introvert would be found in a quiet room attempting to avoid the crowd.

Despite the potential suggestive nature of the quantum mechanical model for the internal states of the human mind, we reiterate here that the present invention does not presume to produce a formal mapping for those. Instead, the present invention is an agnostic application of the tools offered by quantum mechanical formalisms to produce a useful approach of practical value.

Since first subject qubit |iss1 [symbol] is expressed in the chosen u-basis decomposition as |iss1 [symbol] =αₐ|iss1a [symbol] ᵤ+β_{b}|iss1b [symbol] ᵤ (see Eq. 19a) where αₐ and β_{b} are the complex coefficients characteristic of this spectral decomposition, it is easy to mathematically express quantum probabilities pₐ, p_{b} of the two outcomes. Specifically, referring back to Eq. 3, the quantum probabilities are just pₐ=αₐ*αₐ and θ_{b}=β*_{b}β_{b} In embodiments where network behavior monitoring unit 120 (see FIG. 2) is used for curating estimated quantum probabilities pₐ, p_{b}, these are now taken to be equal to the complex coefficient norms α*ₐαₐ and β*_{b}β_{b}. It is the norms that express the probabilities of observing primary internal state 110 of subject s1 yield measurable indications a, b (Introvert, Extrovert) in response to a quantum measurement or, more mundanely put, an act of observation of internal state 110. (Although a rigorous approach might introduce a “hat” or other mathematical notation to differentiate between estimates of probabilities \hat{p}ₐ, \hat{p}_{b} and their actual values pₐ, p_{b}, this degree of sophistication will not be practiced herein. It is important, however, that a skilled practitioner keep the distinction in mind to avoid making common mistakes in implementing the apparatus and methods of the invention.)

The observation can be made by direct inquiry or observing action(s) known to be indicative of internal state 110. In fact, the observation can even be associated with a proposition whose two mutually exclusive responses correspond to the eigenvalues mapped to measurable indications a, b such that: λₐ=R1=a→Introvert, and λ_{b}=R2=b→Extrovert. Of course, in this case we would expect that if the self-report on internal state 110 contained in file 112 transmitted by subject s1 was honest, then the outcome should be a trivial re-test. In other words, the observation should merely recover probabilities exactly as determined in the online personality inventory test of measurable indications a, b mapped to Introvert, Extrovert.

We note here, that unlike the classical descriptions, the present quantum representation necessarily hides the complex phases of complex coefficients αₐ, β_{b}. In other words, an important aspect of the model remains obscured. Yet, we can confirm the values of the probabilities by observation. For example, by performing several measurements of the same measurable indications a, b on a number of subjects with the same measurable indications a, b as subject s1. In the language of quantum mechanics, we are just re-measuring quantum states |iss1a [symbol] ₐ and |iss1b [symbol] that are mapped to Introvert, Extrovert and yield measurable indications a, b with the quantum probabilities pₐ, p_{b}, respectively.

The hidden information contained in the complex phases of coefficients αₐ, β_{b} is a benign aspect of the quantum model for as long as we are considering the same internal state 110 from the same vantage point. In the language of quantum mechanics, complex phases will not become noticeable until we choose to look at subject s1 and their measurable indications of internal state 110 in a different basis (i.e., not in the u-basis shown in FIG. 3B but in some basis where the mutually exclusive states in terms of which internal state 110 is described are, say: Friendly, Unfriendly). The reader is invited to review FIG. 1G and associated description in the background section to appreciate the reasons for this. We will return to this issue further below in our discussion of incompatible observables and commutation relations.

FIG. 3C shows how assignment module 116 assigns a response qubit |rsp [symbol] to subject s1 with respect to proposition 130. Response qubit |rsp [symbol] is placed in a response space [symbol] ᵣₛₚ, which is a Hilbert space according to the requirements of quantum mechanics. Response qubit |rsp [symbol] is also shown on Bloch sphere 10 in the representation form the background section. Response qubit |rsp [symbol] is expressed in a v-basis decomposition into subject response eigenvectors |rspR1), |rspR2 [symbol] ᵥ. The eigenvectors have subject response eigenvalues λ₁, λ₂ that correspond to the at least two mutually exclusive responses R1, R2 that the subject can exhibit modulo proposition 130. In the general example from FIG. 3A, proposition 130 is a “YES” and “NO” proposition and thus R1=“YES” R2=“NO”. Further, since response qubit |rsp [symbol] is expressed in the v-basis decomposition we can write it as:

|rsp [symbol] =α_{R1}|rspR1 [symbol] ᵥ+β_{R2}|rspR2)ᵥ, Eq. 19b

where α_{R1} and β_{R2} represent the complex coefficients.

It is preferred that network behavior monitoring unit 120 curate estimated quantum probabilities p_{R1}, p_{R2} (or strictly, \hat{p}_{R1}, \hat{p}_{R2}) of observing the at least two mutually exclusive responses R¹, R² to quantum measurement of response qubit |rsp [symbol] ᵥ. Therefore, network behavior monitoring unit 120 sets the estimated quantum probabilities p_{R2}, p_{R2} equal to the complex coefficient norms α*_{R1}α_{R1} and β*_{R2}β_{R2} (i.e. p_{R1}=α*_{R1}α_{R1} and p_{R2}=β*_{R2}β_{R2}). Just as in the representation of primary internal state by qubit |iss1 [symbol] ᵤ in the u-basis, correspondent representation of subject response by its qubit |rsp [symbol] ᵥ in the v-basis contains inaccessible information in the complex phases of coefficients α_{R1}, β_{R2}.

FIG. 3D shows us that assignment module 116 assigning a response qubit |rsp [symbol] _{v′} in a v′-basis to subject s1 with respect to a different proposition 130′. In fact, this diagram showing the details of the assignment of the subject's response qubit |rsp [symbol] _{v′} modulo proposition 130′ that re-tests the subject's primary internal state 110 as represented by first subject qubit |iss1 [symbol] ᵤ based on the self-report in file 112. Proposition 130′ thus has to be a re-test or observation of whether subject s1 is an Introvert or an Extrovert. Mutually exclusive responses R1′, R2′ are thus set equal to measurable indications a, b, such that R1′=a→“Introvert” and R2′=b→“Extrovert”.

The additional benefit of such a trivial re-test assignment is the fact that first subject space [symbol] ᵢₛₛ₁ and response space [symbol] _{rsp′} are the same. Also, ray u defining the u-basis and ray v′ defining the v′-basis are the same. This further simplifies issues and bounds the possible sources of error. It is thus of high practical value to perform such an assignment before running any important predictions or simulations to properly calibrate computer system 100. Such calibration will be helpful in determining the level of reliability of self-reports provided by subjects of interest.

As depicted in FIG. 3E, assignment module 116 completes the third of its assignments as dictated by the quantum model adopted herein by generating a proposition matrix PR. Matrix PR is the quantum mechanical representation of proposition 130. In other words, proposition 130 is translated into a linear quantum mechanical operator. To ensure its proper action, proposition matrix PR has the response eigenvectors |rspR1 [symbol] ᵥ, |rspR2 [symbol] ᵥ that, by being paired with eigenvalues R1 and R2 correspond to the two mutually exclusive responses mapped to these eigenvalues that subject s1 can manifest when confronted by proposition 130.

Proposition matrix PR is intended for application to response qubit |rsp [symbol] ᵥ in response space [symbol] ᵣₛₚ. That is because matrix PR is designed to operate on state vectors in the v-basis containing the two response eigenvectors |rspR1 [symbol] ᵥ, |rspR2 [symbol] ᵥ. In the process of collapsing the wavepacket of response qubit |rsp [symbol] ᵥ (see projection postulate in background section) the action of operator matrix PR will extract the real eigenvalue corresponding to the response eigenvector to which response qubit |rsp [symbol] ᵥ collapsed under measurement. Immediately after measurement response qubit |rsp [symbol] ᵥ will be composed of just the one response eigenvector to which it collapsed with quantum probability equal to one. In other words, immediately after measurement for a time period τ during which no appreciable change can take place (i.e., no decoherence through interaction with the environment or unitary evolution) we have either |rsp [symbol] ᵥ=|rspR1 [symbol] ᵥ for sure, or |rsp [symbol] ᵥ=|rspR2 [symbol] ᵥ for sure.

The quantum mechanical prescription for deriving the proper operator or measurement matrix PR has already been presented in the background section in Eq. 13. To accomplish this task, we require knowledge of the decomposition of unit vector \hat{v} into its x-, y- and z-components as well as the three Pauli matrices σ₁, σ₂, σ₃. By standard procedure, we then derive proposition matrix PR as follows:

PR=\hat{v}· σ̅=vₓσ₁+v_{y}σ₂+v_{z}σ₃, Eq. 20

where the components of unit vector \hat{v} (vₓ,v_{y},v_{z}) are shown in FIG. 3E for more clarity.

Proper operation of computer system 100 is contingent on appropriate quantum mechanical assignments. These are largely predicated on knowledge of the relation between first subject qubit |iss1 [symbol] ᵤ and response qubit |rsp [symbol] ᵥ. Knowledge of the relationship between these two assigned qubits can be summarized by two major terms or components.

The first major component is the relationship between subject space [symbol] ᵢₛₛ₁ and response space [symbol] ᵣₛₚ. If the space relationship between [symbol] ᵢₛₛ₁ and [symbol] ᵣₛₚ is such that the spaces are not even remotely “overlapping”, then the likelihood of being able to predict an event probability γ, which is the likelihood that a legitimate quantum measurement can take place will be very small. On the other hand, if the space relationship is “one-to-one”, namely the spaces are the same, then the likelihood of a legitimate quantum measurement will be very high. Knowledge of space relationship can be posited by an expert human curator based on experience or it can be deduced from a statistically large number of quantum measurements.

The second major component is the knowledge of the basis relationship between the u-basis in which the first subject qubit |iss1 [symbol] is decomposed and the v-basis in which the response qubit |rsp [symbol] is decomposed. Based on quantum mechanics and more precisely the commutation relations (see background section and also Eq. 14), we know that even when the space relationship is ascertained to be “one-to-one”, if ray u and ray v define directions of incompatible measurements then even perfect knowledge of first subject qubit |iss1 [symbol] will not tell us the value of response qubit |rsp [symbol] ᵥ. Of course, if n- and v-rays are close to parallel, then the value of response qubit |rsp [symbol] ᵥ can be predicted with a high level of confidence.

In some instances, quantum mechanical incompatibility of u- and v-bases, especially with concurrently poor space relationship ( [symbol] ᵢₛₛ₁ and [symbol] ᵣₛₚ far from “one-to-one”) will make it very challenging to obtain a bona fide quantum measurement. Thus, a quantum interaction probability pᵢₙₜ will need to be adjusted depending on the basis relationship. Furthermore, even in the case of good space relationship (i.e., [symbol] ᵢₛₛ₁, [symbol] ᵣₛₚ essentially “one-to-one”) incompatibility of u- and v-bases may result in subject s1 being unwilling to interact and yield a proper quantum measurement. Hence, event probability γ will also need to be adjusted by quantum interaction probability pᵢₙₜ that depends on basis misalignment between the u- and v-ray.

To make this last point more intuitively apparent, consider the example in which the object of proposition 130 is a political party or a social group (ranging in size from family units to sub-cultures, cultures and nationalities). Now consider a v-basis that decomposes response qubit |rsp [symbol] to proposition 130 along the ray of “YES” and “NO” with respect to personal allegiance and/or financial support for that political party or social group. Now consider a different basis v′ with respect to proposition 130 where the ray v′ decomposes into “YES” and “NO” with respect to liking that same political party or social group. Obviously, the visceral or personal feelings that may be generated during such changes in basis can result in a reduction of quantum mechanical interaction probability pᵢₙₜ due to active disengagement by subject s1 (or the opposite).

In terms of quantum mechanics, we know that switching between incompatible bases is associated with an action on the order of the Planck's constant h or (see discussion of commutation relations in background section). Merely for purposes of building further intuitive insight, we could consider that action to represent a type of “resistance” exhibited by subject s1 to being forced into different bases with respect to proposition 130. The action could manifest in real life by subject s1 actively disengaging from proposition 130 and thus failing to provide any one of the two mutually exclusive responses R1 or R2. This needs to be accounted for by a corresponding reduction in the quantum mechanical interaction probability pᵢₙₜ.

In the present invention it is the function of statistics module 118 to curate event probability γ. It is therefore the function of module 118 to evaluate empirical data concerning the likelihood of measurable events based on classical probabilities, namely null response probability pₙᵤₗₗ and non-engagement probability pₙₑ, as well as such factors as quantum mechanical interaction probability pᵢₙₜ. Once this last probability is properly estimated, event probability γ can be adjusted correspondingly. Most often, event probability γ will be based on probabilities derived from empirical tests on many subjects similar to subject s1, or form initial estimates provided by skilled human curators with experience in the corresponding domains of human behaviors (e.g., psychology or sociology).

Event probability γ is based on the first subject qubit |iss1 [symbol] ᵤ, standing in for subject s1, confronting proposition 130 and engaging therewith to yield a proper quantum measurement of response qubit |rsp [symbol] v. Of course, as the reader has no doubt already surmised from some of the above examples, this will not always happen. Therefore, event probability γ is typically expected to be less than unity (i.e., the event is less than 100% likely. When proposition 130 is about very sensitive subject-object or subject-subject interactions or relationships, event probability γ is expected to be correspondingly low just due to the low value of quantum mechanical interaction probability pᵢₙₜ alone.

In cases where subject s1 actually confronts proposition 130 and engages with it to yield a proper quantum measurement, computer system 100 deploys prediction module 122 to predict the most probable response of subject s1 modulo proposition 130 in the v-basis from the quantum probabilities p_{R1}, p_{R2}. The most probable response is not the actual response but an expectation value or an “average response” that could be expected after a statistically many repetitions of the same question to same subject s1.

Of course, quantum probabilities p_{R1}, p_{R2} of responses R1 and R2 are inherently contained in expectation values and could be computed and output by prediction module 122 instead. However, the quantum mechanical expectation value is frequently a more convenient manner of reporting experimental results. As already seen in the background section (Eqs. 10a&b) it is obtained directly from the quantum mechanical prescription for the expectation value [symbol] PR [symbol] ᵣₛₚ of the proposition matrix PR. This standard quantum computation is performed by sandwiching the proposition matrix between the bra and ket state vectors expressing response qubit |rsp [symbol] thus yielding:

[symbol]

PR [symbol] ᵣₛₚ= [symbol] rsp|PR|rsp [symbol] . Eq. 21

For example, an expectation value of zero will mean that response R1 is as likely as response R2. Thus, over statistically many repetitions of the same experiment with subject s1 given their first internal state subject qubit |iss1 [symbol] , proposition 130 and their response qubit |rsp [symbol] we will get as many responses R1 as R2. The quantum probabilities p_{R1}, p_{R2} of R1 and R2 are immediately apparent from the expectation value, namely: 50/50.

Now, before addressing more difficult cases and discussing event probability γ and the components that contribute to it in more detail, we will consider the simple calibration case already hinted at in the above teachings.

### The Ideal Case and System Calibration

The above initial and agnostic assignments executed by assignment module 116 provide a naive mapping of primary internal state 110 of subject s1 and their reaction modulo proposition 130 to a quantum mechanical representation using qubits |iss1 [symbol] ᵤ, |rsp [symbol] ᵥ inhabiting Hilbert spaces [symbol] ᵢₛₛ₁, [symbol] ᵣₛₚ. The assignments also devised an observable represented by proposition matrix PR designed to act on response qubit |rsp [symbol] ᵥ. The action of matrix PR on response vector |rsp [symbol] ᵥ will precipitate a proper measurement in the quantum sense. In principle, knowledge of subject qubit |iss1 [symbol] ᵥ its relationship to response qubit |rsp [symbol] ᵥ, quantum mechanical interaction probability pᵢₙₜ and any intervening classical probabilities, such as the classical probabilities pₙᵤₗₗ, pₙₑ, would enable computer 108 to run an ideal version of prediction algorithm 110.

Although such ideal case is rarely envisaged, it will be instructive to review it. This idealized analysis will help us to build some additional intuitive insights prior to delving into more practical embodiments. For the time being, we will assume that probabilities of null response and non-engagement pₙᵤₗₗ, pₙₑ and any other intervening classical probabilities are all equal to zero. In other words, we are sure that we will set up the quantum measurement we seek to make. We will also assume for now that the quantum mechanical interaction probability pᵢₙₜ is equal to one; i.e., each experiment on subject s1 (or similarly prepared subject) will produce a measurement.

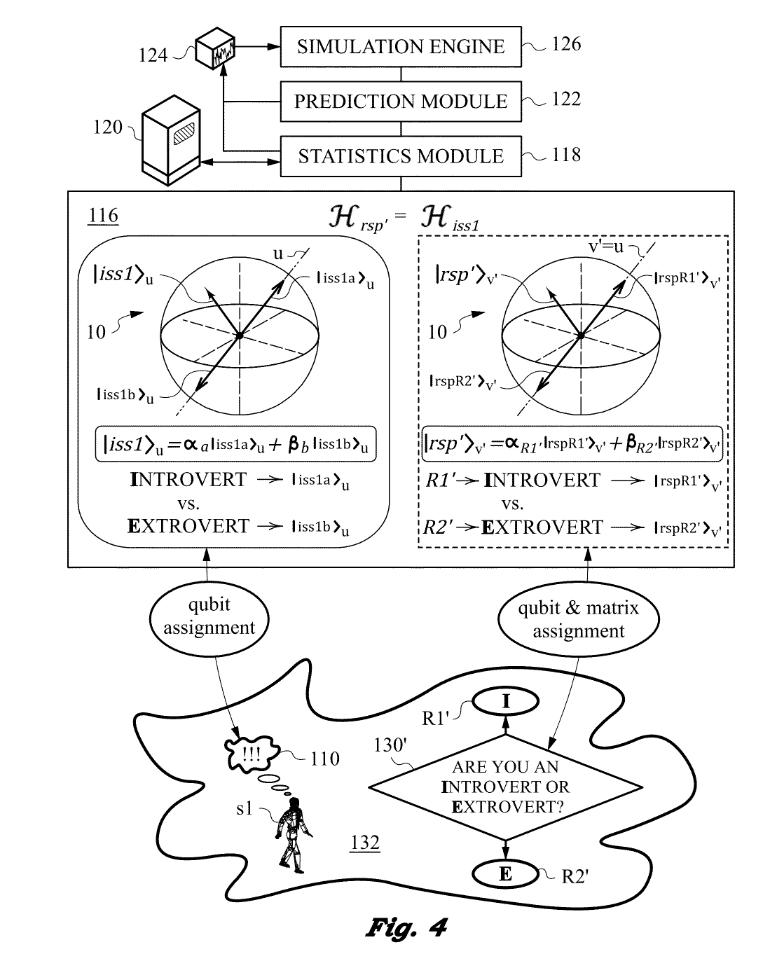

An exemplary ideal situation is illustrated in the diagram of FIG. 4, which illustrates only the immediately relevant parts of computer system 100. In the ideal situation, as in one of the prior examples, subject qubit |iss1 [symbol] ᵤ represents dyadic internal state 110 (Introvert vs. Extrovert) that decomposes into eigenvectors |iss1a [symbol] ᵤ, |iss1b [symbol] designating Introvert and Extrovert, respectively. We have already seen this situation arise for subject s1 in FIG. 3B. To simplify the notation in this example, internal states of Introvert and Extrovert will be abbreviated by capital letters I and E in accordance with standard Jungian and Myers Briggs conventions. We will also assign these letters to the eigenvalues for convenience.

Now, proposition 130′ that subject s1 is confronted with, either online or in a real-life context 132, is yet again a question about the very same internal state 110. In other words, proposition 130′ is also about the dyadic internal state of subject s1 (Introvert vs. Extrovert) as previously shown in FIG. 3D. Thus, proposition 130′ is merely a re-test of the already established primary internal state 110 of subject s1 that was either self-reported or inferred.

Under these conditions, response qubit assignment performed by assignment module 116 is particularly simple. Module 116 takes the already known subject qubit |iss1 [symbol] and assigns it to response qubit |rsp [symbol] _{v′} as depicted in FIG. 3D. As already pointed out, in this case u-basis of subject qubit |iss1 [symbol] and v′-basis of response qubit |rsp [symbol] _{v′} are identical, u=v′. Furthermore, qubits |iss1 [symbol] , and |rsp′ [symbol] _{v′} reside in the same Hilbert space so that [symbol] ᵢₛₛ₁= [symbol] ᵣₛₚ. Given this “one-to-one” space relationship and no basis misalignment between u and v′ (u=v′) no quantum-related adjustments need to be made to event probability γ. Furthermore, as already hinted above, we will also presume a perfect 100% quantum interaction probability pᵢₙₜ. We thus expect all trials to yield valid quantum mechanical measurements.

In fact, the results will be excellent for training or tuning network behavior monitoring unit 120, calibrating statistics module 118 and for estimating the truthfulness of self-reports by subject s1 and a number of other subjects with similar preparation (i.e., similar test results related to Introversion and Extroversion). Clearly, the method of the invention is already a highly useful tool for performing a cross-check on already collected subject behavior data that is presently handled on computer systems and clusters by classical algorithms.

Returning to FIG. 4, we note presence of subject s1 in context 132 in which re-test will occur. The time elapsed between taking online personality inventory test by subject s1 and generation of file 112 is short enough to preclude any significant change in internal state 110 of subject s1. Under normal circumstances such change takes place though life-altering interactions with others, or over the course of natural aging. A person skilled in the art of human developmental and behavioral science will be able to approximate the correct time period τ. In the framework of the presently adopted quantum mechanical description, life-altering interactions will be attributed to environmental decoherence. Undisturbed evolution, meanwhile, will be attributed to unitary evolution of the state vector as governed by some unitary operator. Of course, the correctness in the choice of time period τ can itself be tested by the present system and method, thus providing another beneficial result.

Because of the stability of a human being's personality with respect to their internal subject state of Introversion vs. Extroversion, the initial choice of time period τ is on the order of years from the time of taking the test for a mature subject. After a decade or more, data in file 112 pertaining to the test may no longer be “fresh” enough (as can be confirmed by checking the time stamp). Clearly, identification of very stable and relatively pure internal states is of great value in present as well as prior art systems and methods of human behavior prediction.

Once assignment module 116 completes its quantum assignments as shown, statistics module 118 can provide its curated event probability γ based on first subject qubit |iss1 [symbol] for subject s1 confronting proposition 130′ (Introvert vs. Extrovert to yield a quantum measurement of response qubit |rsp [symbol] _{v′}. As remarked above, we will take event probability γ to be 100% for the ideal case. In general, however, statistics module 118 curates event probability γ from large samplings of subjects on network 104 with analogous preparation to subject s1 confronting proposition 130′ in context 132. For this reason, statistics module 118 communicates with network behavior monitoring unit 120 to periodically extract the statistics it needs to curate up-to-date event probability γ for the situation (s) under study.

The assignments along with up-to-date event probability γ are then forwarded to prediction module 122. The job of module 122 is to predict the most probably response of subject s1 modulo proposition 130′ from the quantum mechanical expectation value [symbol] PR [symbol] ᵣₛₚ of proposition matrix PR. This computation is performed according to Eq. 21, since we are operating under the assumption that we are working with reasonably pure quantum states.

The expectation value [symbol] PR [symbol] ᵣₛₚ derived by prediction module 122 is a very useful measure, but not always the best fit for practical applications, such as simulations of behaviors of groups of subjects analogous to subject s1. Thus, when simulation engine 126 connected to prediction module 122 receives its output it proceeds to convert it to a series of responses R1′ and R2′. In other words, simulation engine 126 preferably works with quantum probabilities of collapse of response qubit |rsp′ [symbol] _{v′} to the two possible eigenvectors |rspR1′ [symbol] _{v′}, |rspR2′ [symbol] _{v′} for a series of occurrences or instances, rather than the expectation value [symbol] PR [symbol] ᵣₛₚ.

As we have already learned above, these quantum probabilities are obtained from the norms of the complex coefficients α_{R1}, β_{R2} of the decomposition of response qubit |rsp [symbol] ᵥ (see Eq. 19b). Thus, simulation engine 126 simply applies the standard rule of quantum mechanics already stated above and computes the quantum probabilities that p_{I} and p_{E} of recording eigenvalues R1′ (“Introvert”), R2′ (“Extrovert”) as follows:

p_{I}=α*_{R1′}α_{R1″} Eq. 22a

p_{E}=β*_{R1′}β_{R1″} Eq. 22b

where we remember that p_{I} and p_{E} sum to one, since response qubit |rsp [symbol] _{v′} is normalized.

In a preferred embodiment, simulation engine 126 uses random event mechanism 124 to generate a time series of eigenvalues R1′ (“Introvert”), R2′ (“Extrovert”) with the correct quantum probabilities p_{I} and p_{E}. In most cases, generating such results requires that random event mechanism 124 be initially seeded with quantum probabilities p_{I} and p_{E} For this reason, mechanism 124 is connected to prediction module 122 to receive its output and derive therefrom the requisite information. An exemplary random event mechanism 124 can be embodied by a random number generator, a pseudo-random number generator or any suitable generator of random or quasi-random sequences either derived from physical phenomena (e.g., circuits with a Josephson's junction) or based on a computational method.

Used in combination with mechanism 124 simulation engine 126 can thus produce a life-like or realistic simulations of subject s1 and a large number of subjects similar to subject s1 being confronted by proposition 130′ and responding to it with responses eigenvalues R1′ (“Introvert”), R2′ (“Extrovert”). Many external applications and mechanisms (not shown) can be supplied with such simulations to their own ends.

Most importantly, performing a test run in which the proposition posed to subject s1 is the same as the one that characterized the primary internal state of subject s1 is useful for calibration. Such calibration can discover whether various aspects of the system and method have been correctly implemented. When response qubit |rsp [symbol] _{v′} is observed to yield the same quantum probabilities as those originally obtained for primary internal state |iss1 [symbol] ᵤ then the system is well calibrated.

Once calibration is achieved, small deviations can be tested to gain a better understanding of the system and method under the particular settings. For example, less fresh subject data can be used to see the effects of decoherence and state evolution over time. This will permit the system designer to confirm the value of time period τ. Subjects with progressively different preparations from subject s1 can be submitted to the test to see the progressive divergence in results and estimate the robustness of the method in this particular setting. Furthermore, different states where reliability of the self-reports becomes more questionable can be tested to examine the effect of poor knowledge of internal state or inaccurate reporting by the subject. This information can be translated into the amount of state vector perturbation present in the data sets. A person skilled in the art will realize that the re-test condition is an excellent set-up to tune and trouble-shoot the method and system prior to exploring more difficult internal states, propositions and contexts.

### Practical Embodiments

Once the re-test has been performed to calibrate and trouble-shoot system 100 and the method, more challenging measurements can be undertaken. First, because the occurrence of events leading to quantum measurement in a non-ideal case is contingent on event probability γ, mechanism 124 is additionally connected to statistics module 118. From it, mechanism 124 receives the requisite classical and non-classical probabilities (pₙᵤₗₗ, pₙₑ, pᵢₙₜ) necessary to generate its time series of quantum measurements that drive simulation engine 126.

Preferably, the two classical probabilities (pₙᵤₗₗ, pₙₑ) are computed separately by network behavior monitoring unit 120 based on a large number of historical instances where subject s1 either chose non-engagement or, after being confronted with propositions of similar nature exhibited null responses. Alternatively or in combination, null response probability pₙᵤₗₗ can be derived from statistically large number of instances involving many subjects similar to subject s1 being confronted with propositions. The same approach can be taken in determining non-engagement probability pₙₑ and unit 120 is best positioned to curate this probability.

In other embodiments, background numbers averaged over all subjects and all types of propositions can be used. The computation of probabilities pₙᵤₗₗ, pₙₑ is entirely classical and based on data available to unit 120 in network 104, including any social group 106 (see FIG. 2). In fact, a person skilled in the art of statistics will find myriads of different approaches that can be deployed to compute pₙᵤₗₗ, pₙₑ. Any of these can be employed by unit 120 or any other part/module tasked with curating event probability γ. Even presently computed “click-through”, “hover no click” and related metrics gathered in present-day systems can be adapted to compute pₙᵤₗₗ, pₙₑ in agreement with standard practices.

In addition to classical probabilities pₙᵤₗₗ, pₙₑ, event probability γ contains the likelihood that based on first subject qubit |iss1 [symbol] ᵤ assigned by module 116 subject s1 will actually confront proposition 130 that leads to quantum measurement by proposition matrix PR of response qubit |rsp [symbol] ᵥ. This component is referred to herein as quantum interaction probability pᵢₙₜ. It is intended to account for additional effects on event probability γ that cannot be accounted for with classical probabilities. Therefore, quantum interaction probability pᵢₙₜ is assumed to be contingent exclusively on the quantum parameters of the representation chosen in the present model. These include primarily the space relationship between subject space [symbol] ᵢₛₛ₁ and response space [symbol] ᵣₛₚ and the relationship between the rays defining the u-basis and v-basis.

The basis relationship between first subject qubit |iss1 [symbol] ᵤ decomposed in the u-basis and response qubit |rsp [symbol] ᵥ decomposed in the v-basis is not even significant if subject space [symbol] ᵢₛₛ₁ and response space [symbol] ᵣₛₚ are too distant from each other. The space relationship is an empirical parameter that should initially be set by a human expert with requisite experience in internal states and propositions under study. Alternatively, space relationship can be explored systematically starting out from the re-test condition. In particular, by progressively varying the proposition away from a known original proposition in an exploratory fashion one can observe the change in space relationship. This can be viewed as progressively changing the context.

To understand such exploration and variation of context we turn to the diagram in FIG. 5, where the measurement of response qubit |rsp′ [symbol] ᵥ under the calibration or re-test condition treated above is visualized in more detail. In this case the space relationship is “one-to-one” ( [symbol] ᵢₛₛ₁= [symbol] _{rsp′}) and thus we can put its impact on quantum interaction probability pᵢₙₜ in abeyance.

The diagram expressly indicates quantum probability p_{I} of observing subject s1 “collapse” into the “Introvert” state represented by state vector |rspR1′ [symbol] _{v′} and yield the measurable indication represented by eigenvalue R1′ (“Introvert”) by the size of a circle. The same goes for measurable indication represented by eigenvalue R2′ (“Entrovert”), which is clearly much less probable given the estimated response qubit |rsp′ [symbol] _{v′} shown in FIG. 4. This useful visual aid was already used in the background section (see FIG. 1C) to remind us that according to the rules of quantum mechanics only one of the two eigenvalues can be measured: either R1′ (“Introvert”) or R2′ (“Extrovert”) in a legitimate quantum measurement (not an in-between projection along the ray v′).

Of course, as we already learned in the background section (see FIG. 1E and associated text) measurement or collapse of state |rsp′ [symbol] _{v′} to |rspR1′ [symbol] _{v′} as shown in FIG. 5, will have consequences on any subsequent measurement. Once in this collapsed state of being a confirmed Introvert, asking subject s1 the same question within a short time period τ (i.e., before decoherence or state evolution has taken place) will yield the exact same result, namely Introvert with 100% certainty. However the answer to a new question representing a new take on the same underlying proposition, in other words changing the context, to a different proposition characterized by a set of two mutually exclusive answers may not be known with certainty.

Consider a new context where the underlying proposition is recast and the new question has response states characterized by a decomposition along a ray v′^{⊥}. In the Bloch representation ray v′^{⊥} is contained in a plane 134 that is essentially perpendicular to ray v′. We know from the discussion of uncertainty in the background section that any measurement along a ray contained in plane 134 will therefore yield equiprobable results (50/50). In our model, this means that the answer of subject s1 to a question that is “perpendicular” to the original question about Introversion vs. Extroversion but related to the same underlying proposition (namely the subject's primary internal state assigned subject qubit |iss1 [symbol] ᵤ) will be completely unpredictable. For example, if ray v′^{⊥} defines a proposition based on the same underlying proposition but framed by possible mutually exclusive responses of FRiendly and UnFriendly, the corresponding probabilities p′_{FR}, p′_{UF} will be equal. Thus, the answers will be equally likely, as indicated by the circles in FIG. 5. Once again, that is the effect of the Heisenberg Uncertainty Principle on the model adopted in the present invention.

In fact, the Uncertainty Principle is possibly the best tool for exploring basis misalignment between various questions relating to the same underlying proposition. This approach is preferably deployed in conjunction with curation of propositions under supervision of a skilled human expert. Note that experimental reconstruction of physical situations based on the Uncertainty Principle use the tools of commutators (see Eq. 14 in the background section) and find extensive applications in the field of physics. Therefore, the practitioner of the present invention will be able to borrow heavily from the techniques used there.

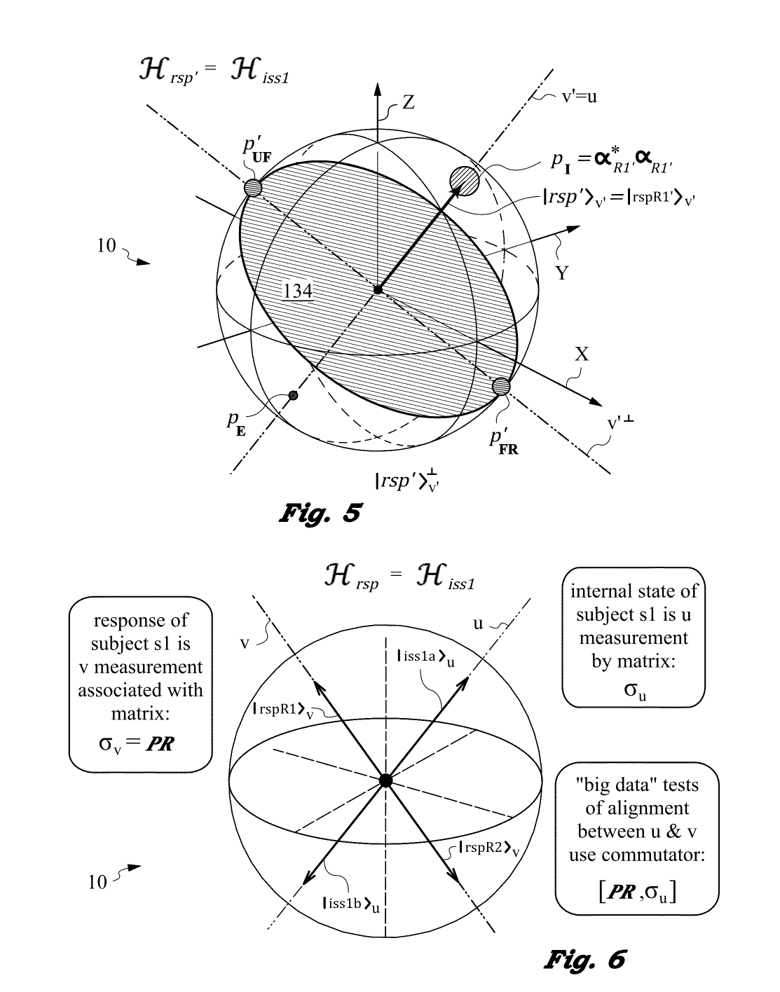

We now turn to FIG. 6 to find an immediate practical application of the commutator. Here Bloch sphere 10 depicts the original proposition 130 introduced in FIG. 3B that was not aligned with ray u and whose mutually exclusive answers were simply R1=“YES” and R2=“NO”. The decomposition of proposition 130 is along ray v. In many situations, the orientation between rays u and v will be unknown. That is because even the best human curator will be only able to guess at initial orientations based on experience with human subjects and their experience of corresponding internal state and the nature of proposition 130. However, thanks to the tools supplied by well-known commutator algebra the orientation of u and v can be narrowed down based on measurements.

Here the next advantage of the present system and method comes into focus. The availability of “big data”, in other words the massive number of self-reports by subject s1 as well as many other subjects that are prepared in the same or essentially the same ways as subject s1 are now available to behavior monitoring unit 120. By reaching into the archives in memory 108 where the time-stamped and classified files 112 containing that data have been placed by unit 120, we can discover the orientation between u and v bases empirically.

FIG. 6 indicates the correct proposition matrix PR which goes with measurements of proposition 130 in terms of the answers R1=“YES” and R2=“NO”. Meanwhile, a matrix constructed using the same tools as proposition matrix PR, here designated as σᵤ is constructed for measurements of proposition 130 in terms of the mutually exclusive measurable indications that go with the primary internal state, namely: a=“Introvert” and b=“Extrovert”. Again, it is useful to consider these two situations as two different contexts modulo the same underlying proposition.

The issue at hand is how incompatible are these two contexts modulo the same underlying proposition. In the language of quantum mechanics, the question becomes a mathematical one. It is quantified by the value of the commutator of the matrices associated with the contexts as follows:

[PR,σᵤ]=PRσᵤ−σᵤPR=MA, Eq. 23

where MA stands for the measure of axial misalignment between u and v. Note that no misalignment will be discovered if measure MA is zero. In other words, if operators σᵤ and PR commute then they are simultaneously measurable (also see discussion of Complete Set of Commuting Observables or CSCO in the background section).

To determine the answer computer system 100 takes full advantage of “big data”. With the aid of network behavior monitoring unit 120 it collects and archives in memory 108 a large number of files 112 for identically prepared subjects. This means subjects with the same primary internal state 110 and hence described by the same subject qubit |iss1 [symbol] ᵤ. Then, by any suitable procedure (e.g., by running a monitoring script), unit 120 tags within a time period τ all subsequent measurements of these subjects in the context associated with matrix PR. As indicated above, time period τ is selected to be short enough to ensure minimal decoherence and state evolution of state vectors describing the subjects.

Unit 120 then associates or flags these second measurements of the subjects in any suitable way, such that statistics module 118 finds the results. Note that these measurements are in the temporal order of order primary internal state and then the proposition. This corresponds to applying matrix σᵤ first and then matrix PR to state vector |iss1 [symbol] ᵤ.

Unit 120 also collects data on subjects that underwent the exactly opposite treatment. Namely, they first were found in an eigenstate of the proposition represented by matrix PR. Then, within acceptable time period τ, they took the online test and were thus measured by matrix σᵤ. Once again, these results are collected and flagged by unit 120 for statistics module 118.

From these measurements, statistics module 118 can construct the commutator of Eq. 23 and determine measure MA of axial misalignment. It should be noted, of course, that the qubit used in the representation has three incompatible observables and not two. Therefore, two incompatible matrices σᵤ, PR will not span the qubit's space. However, as the skilled artisan will realize, the commutator techniques can be used to add and test more contexts modulo the same underlying proposition. Performing this in a concerted fashion and taking advantage of “big data” will permit one to more completely determine the space of the qubit and which propositions are totally incompatible. Further, if the dimensionality of the space is found to exceed that of the two-state system, a qubit offering a higher-dimensional representation can be adopted (e.g., a spin 3/2 or even a spin 5/2 object).

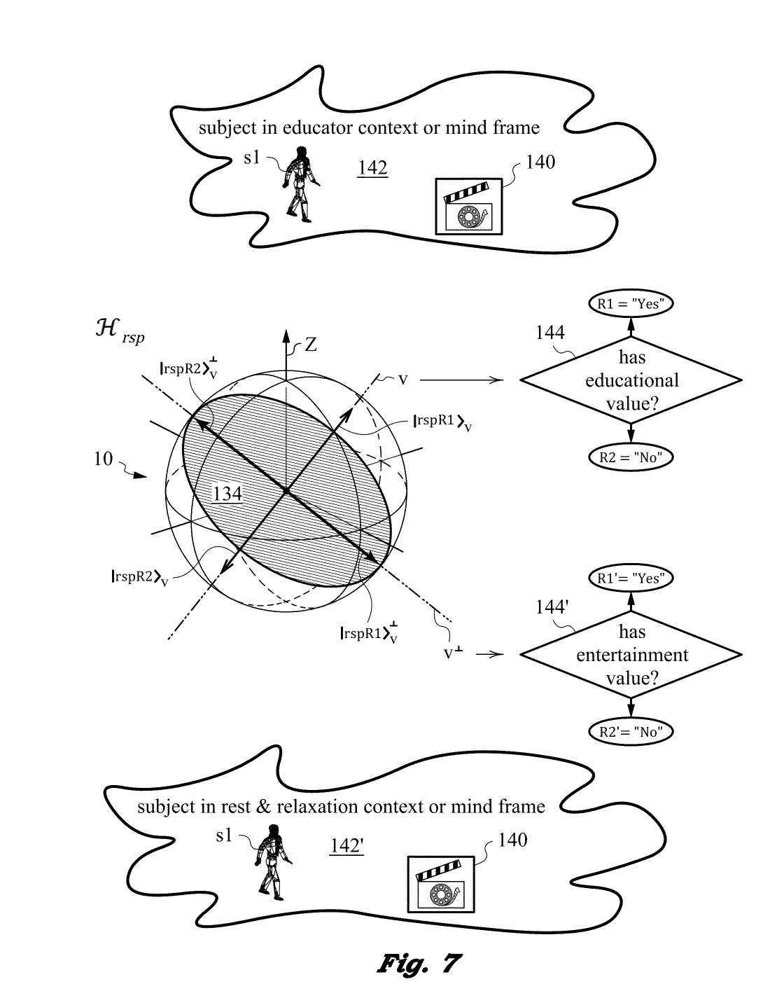

From the point of view of the human expert curator, the natural question that arises here is this: when are we talking about the same underlying proposition but in different contexts and when is it no longer the same underlying proposition? To answer this question in a manner that is better reconciled with our human intuitions we turn to the example in FIG. 7.

FIG. 7 is a diagram showing how to explore incompatible contexts modulo the same underlying proposition constituted by an object 140, here a specific movie that subject s1 can view. Note that the identity of the underlying proposition is simple to establish because it is about movie 140 in all situations. Differently put, it is the object 140 that the interaction is about it is the centerpiece about which different contexts or mind frames of subject s1 can emerge. In other words, regardless of the context, this is a subject-object interaction between subject s1 and movie 140. What the interaction is fundamentally “about” remains constant.

There are two distinctly different ways in which subject s1 can contextualize and consume object 140. In mind frame 142, subject s1 is fulfilling his or her duties on the education board in reviewing content for education value. FIG. 7 associates this context modulo the underlying proposition of viewing movie 140 (interacting with movie 140) with measurement of response qubit |rsp [symbol] ᵥ of subject s1 along the v ray. The corresponding proposition that contextualizes this measurement is designated as 144 and it admits of two mutually exclusive responses; “YES” and “NO”.

In mind frame 142′, subject s1 is on an exciting vacation away from their regular life and work. Hence, same subject s1 now contextualizes items such as movie 140 in the rest and relaxation context or mode. A trained human expert in behavioral and developmental science would likely assume that this context modulo the underlying proposition of viewing movie 140 is somehow incompatible with context 142. In our quantum mechanical representation, a first estimate of such an experienced curator might be to represent measurement of response qubit |rsp [symbol] ᵥ_{^{⊥}} of subject s1 in a perpendicular basis, namely v^{⊥} somewhere in plane 134 (also see FIG. 5). In this new context 142′, subject s1 can render two mutually exclusive responses: “YES” and “NO”. The proposition evoking these possible responses is designated by reference numeral 144′.

The responses are the same in both contexts 142, 142′. Evidently, they now represent projections onto an entirely different (presumably incompatible) basis vectors. A “YES” in context 142 where subject s1 considers movie 140 as an educator collapses to state vector |rspR1 [symbol] ᵥ.

A “YES” in context 142 where subject s1 considers movie 140 as a frolicking vacationer collapses to state vector |rspR1 [symbol] _{v′}. Notice that these two state vectors are perpendicular to each other in the Bloch picture and hence incompatible in the Heisenberg sense. This also means that it would be impossible to measure both of them at the same time. A human conclusion to be drawn from this is that subject s1 cannot simultaneously behave as an educator and frolicking vacationer modulo movie 140 (and possibly modulo a number of other objects and subjects).

Of course, given the fallibility of even the most astute human expert curator, the exact misalignment between rays v and v^{⊥} could be off in the initial set-up. Hence, the system designer should employ the commutator algebra techniques discussed above to properly tune the representation for this application. Once again, the availability of “big data” in invaluable for this purpose. Prior to the advent of ubiquitous self-reporting via network 104 and social groups 106 it would not have been feasible to collect all the data required to properly calibrate the model.

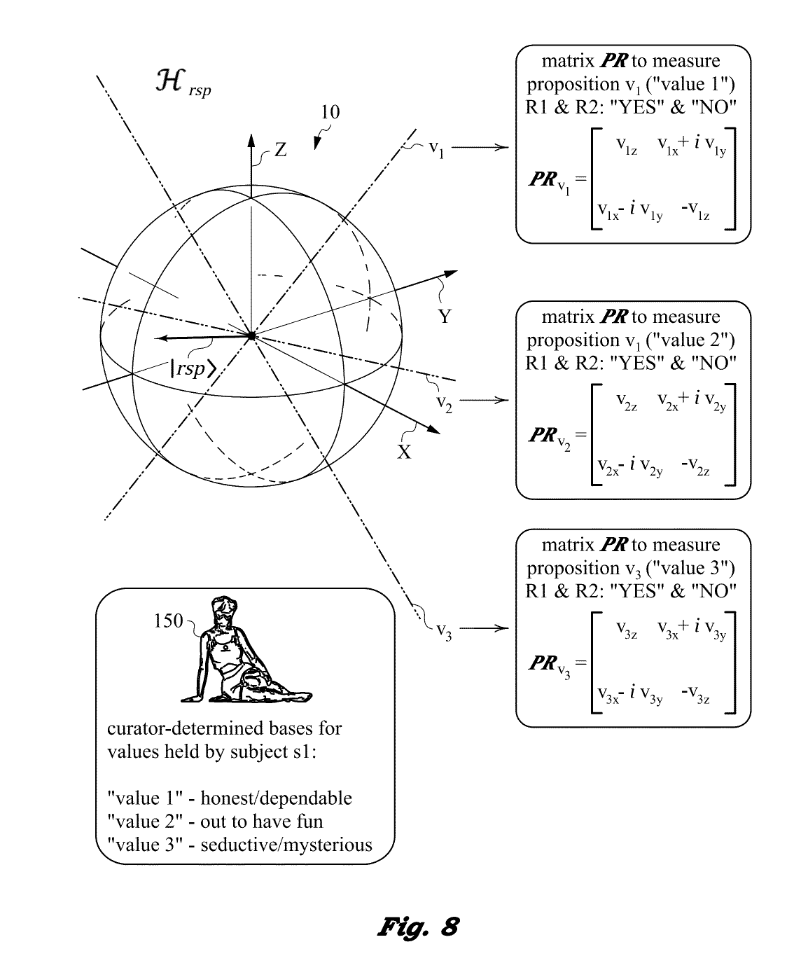

Another useful and practical embodiment is presented in FIG. 8. The object of the underlying proposition here is another subject 150. Subject s1 is not shown in this drawing. In this application, the response qubit |rsp [symbol] in response space [symbol] ᵣₛₚ shown in Bloch sphere 10 belongs to subject 150. The application is a matching program to attempt to facilitate subject s1 meeting a desirable match. Subject 150 is the potentially desirable match.

The curator first establishes contexts that subject s1 values or considers important in their life. There are three of those in the present example and they will henceforth be referred to as subject values. In FIG. 8 the curator has established three rays v₁, v₂, v₃ that associate to subject values and define different bases for response qubit |rsp [symbol] . These rays indicate measurement bases in which subject s1 wishes to discover subject 150 match their desired responses.

Of course, values v₁, v₂, v₃ need not be either compatible or incompatible in the Heisenberg sense. It is most likely that some are fairly well aligned while others are not. Thus, it cannot be expected that subject 150, or any other subject for that matter, may be able to match the responses desired by subject s1 along all three values simultaneously. Furthermore, as we have already gleaned from the present quantum representation and the conditions imposed by commutation algebra, the order in which values v₁, v₂, v₃ are measured will matter. In other words, responses elicited from subject 150 will likely differ depending on the order in which the questions that measure the three values are asked.

FIG. 8 shows the direct translation of the situation into the quantum mechanical representation of the present invention. Specifically, proposition matrices PRᵥ_{₁}, PRᵥ_{₂}, PRᵥ_{₃} corresponding to measurements of the three values v₁, v₂, v₃ important to subject s1 are shown explicitly. Better stated, subject s1 actually wants to see certain responses to the measures of response qubit |rsp [symbol] of subject 150 along the rays defining these values. For simplicity, all measurable indications are just answers have the two mutually exclusive responses of “YES” and “NO”.

The exercise of arriving at the initial relative orientations of values v₁, v₂, v₃ is left to the reader. Thankfully, because of “big data” their relative orientations and consequently basis misalignment can be determined experimentally by following the above-mentioned procedures and any suitable mathematical conveniences imported from the field of applied and experimental physics.

The last example is also helpful in addressing the issue of space relationships that affect quantum interaction probability pᵢₙₜ. In particular, space relationship in the sense of the present invention has to do with an “overlap” between qubits. Clearly, when the same quantity is measured repeatedly on the same system the space relationship is “one-to-one”. However, in many practical situations this is not the case.

In the example of FIG. 8 an implicit assumption is made that values v₁, v₂, v₃ even exist in the space of potential match 150. However, it is entirely possible that a value in the space of subject s1 is nonexistent in the space of subject 150. There are numerous examples of such “non-overlap” in real life. For example, a subject deeply interested in sports may exhibit values that are not shared by a subject engaged in purely altruistic or only intellectual pursuits. Of course, fundamental or simple values are generally shared based on all subjects sharing the same biology.

Estimating a space relationship between qubits is preferably performed by a human expert curator, as before. In addition, network behavior monitoring unit 120 is preferably engaged in collecting “big data” to confirm the existence of space overlaps. Furthermore, statistics module 118 preferably calibrates its estimates of space relationship for any particular model or test. It does so by searching for records of mutual agreements between subjects in network 104 that exhibit traits that associate with non-overlapping and overlapping spaces. Such information is most frequently found in social network 106, where users “like” or “dislike” certain items posted by other users.

Records of interaction, whether by positive or negative reaction, indicate that there is likely an overlap in spaces. Absence of such records indicates that there is likely no overlap in spaces.

The present method and apparatus is not designed for situations of no or virtually non-existent overlap in spaces. In these situations statistics module 118 assigns a quantum interaction probability pᵢₙₜ of zero and may issue a system halt to prediction engine 122 and the other components of system 100 involved in quantum computations and simulation. On the other hand, when the space relationship is sufficiently close so that the contribution of space relationship to quantum mechanical interaction probability pᵢₙₜ is large, then statistics module sets pᵢₙₜ to a number correspondingly close to one. Then, it compounds interaction probability pᵢₙₜ based on the basis relationship discussed above.

In practical settings it is preferred that statistics module 118, coordinate determination of interaction probability pᵢₙₜ with network behavior monitoring unit 120. That is because the latter can be issued scripts and other network tools to track down the requisite data most efficiently. Once the number for interaction probability pᵢₙₜ is available, it is used to adjust the overall event probability γ. This number is then also used by prediction module 122 as well as random event generation mechanism 124 to seed simulation engine 126 with the most appropriate temporal sequence of events or occurrences. Of course, the final probability of particular occurrences is then still subject to quantum measurement. Thus, prediction module 122 still has to apply quantum probabilities p_{R1}, p_{R2} (or strictly speaking estimates, \hat{p}_{R1}, \hat{p}_{R2}) of collapse to one or the other state vector to get the final outcome. Mechanism 124 needs to do the same in supplying simulation engine 126.

It is also desirable, as a system cross-check, to compute event probability γ based on its classical and quantum components and then compare with the results of experiments. The availability of “big data” and access to large networks with instant updates posted by subjects renders this a practical option. Such cross-check is especially important because of the compound nature of event probability γ. Improper assignments of probabilities or “cross-talk” between them have to be kept to the lowest level to ensure good operation of system 100.

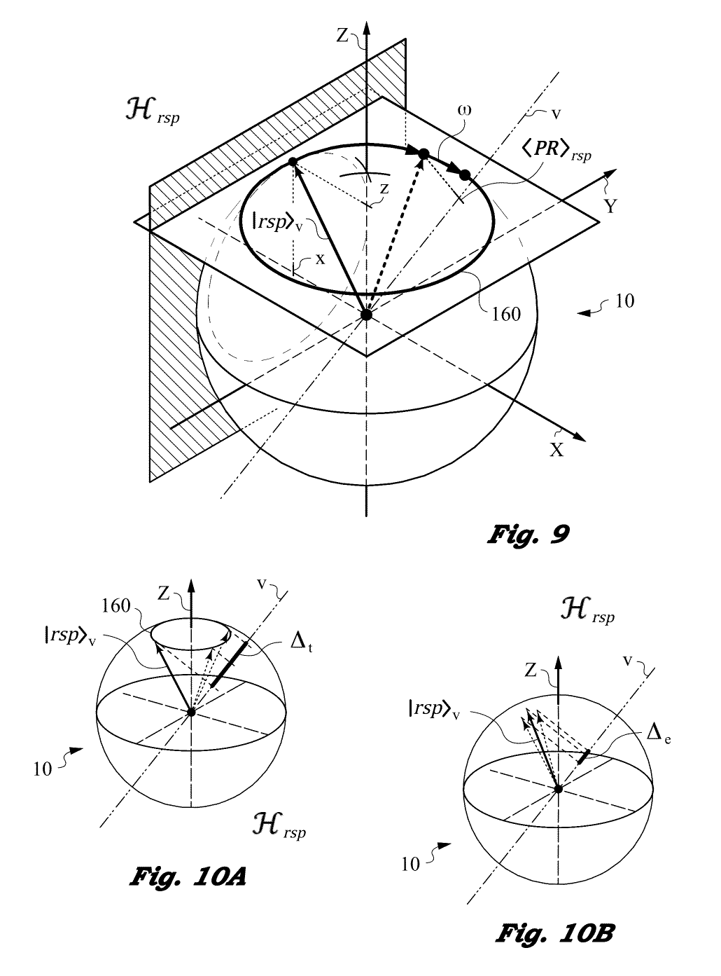

Next we turn to the topic of errors. FIG. 9 illustrates a typical temporal evolution of qubit in Bloch sphere 10. Note that over time qubit |rsp [symbol] ᵥ precesses about a certain direction. In this case it is the Z axis, which is clearly not the same as the direction indicated by ray v. Thus, the projection of qubit |rsp [symbol] ᵥ onto v is time-dependent. The angular rate of this precession is designated by w. The trajectory is indicated by reference numeral 160. At the instant shown in FIG. 9, the projection obtained by computing the expectation value of proposition operator [symbol] PR [symbol] ᵣₛₚ is near its maximum.

It is now clear to the reader why bounding experiments to comparatively short time period τ or choosing long-term stable states is important. It allows us to avoid natural changes in states due to its temporal evolution.

In some situations, however, the states of interest will be ephemeral. FIG. 10A is a diagram illustrating how to account for error due to temporal evolution of state |rsp [symbol] ᵥ shown in FIG. 9. In particular, we need to account for its precession along trajectory 160 whose instantaneous projection along v will typically be unknown. For best results, the angle between state vector |rsp [symbol] ᵥ and the axis of precession should be small. By collecting a large stream of time-stamped of data about the one or more subjects exhibiting the same preparation via unit 120, statistics module 118 is able to bound the evolution between a largest and smallest projection.

The difference between these maximal and minimal projections is designated as Δₜ in FIG. 10A. Most preferably a phase or some other indication of timing, i.e., when the projections tend to be ebbing or cresting would be helpful. In the absence of such information, the difference Δₜ is passed to prediction module 122 to add as an error term into its prediction model.

FIG. 10B is a diagram illustrating how to account for error due to misreports and other bounded sources of inaccuracy in qubits by a perturbation term Δₑ. These errors can be due to inaccurate self-reports for any reason. As a result, they do not result in any precession governed by a unity operator or other predictable trajectory of qubit |rsp [symbol] ᵥ. Instead, they are presumably random. Hence, the application of a perturbation technique well-known in the art is appropriate. Once again, we rely on “big data” to bound the random scatter for subjects prepared in the same manner. Then, the corresponding spread of projection on v is derived and captured by perturbation term Δₑ. The latter is passed on to prediction module 122.

Although we are here showing corrections Δₜ, Δₑ for the more likely state to be affected, the same can be done for first subject qubit |iss1 [symbol] . In other words, the latter can also be adjusted by a perturbation term and/or a temporal evolution term.

From the above teachings it should be clear that the preferred embodiments of the invention involve networks and social groups. Due to the advantages of “big data”, the method and apparatus are used for predicting the responses of subjects that are online, possess a documented online presence and are potentially members of social networks or groups. It is convenient to compile event probability γ for a group of subjects based on inferred and observed data (e.g., data from behavior monitoring unit 120) for the given subject. Thus, a database of event probabilities can be compiled for an entire group of subjects. Subjects in the group should be selected based on a subject qubit similarity measure (same preparation) to the first subject qubit |iss1 [symbol] in order to be truly useful. In fact, a qubit similarity measure that indicates how relaxed the parameter of same preparation is permissible can be deployed to select the group of subjects to which the findings for the subject in question will be considered applicable. Of course, a master curator, e.g., a human being with experiential knowledge of states described by subject qubit |iss1 [symbol] and response qubit |rsp [symbol] should participate in the curation process.

It is also convenient to compile the event probability γ for the subject based on instances of observed data (e.g., network behaviors recorded by the network monitoring unit) collected at different times. Using this information permits curation of a more refined event probability γ for the subject. Indeed, data observed at different times can also help with other quantum mechanical parameters, as will be appreciated by the skilled artisan.

In a preferred embodiment of the invention and as already hinted at above, random event mechanism 124 is used not only for simulating the quantum measurement of response qubit |rsp [symbol] yielding responses R1, R2 with quantum probabilities p_{R1}, p_{R2}, but also to include in the simulation the complete event probability γ. In other words, the random event mechanism preferably uses the classical and quantum probabilities to determine whether the event will take place and only in the case of an event, will it use its random number generation capability for the quantum measurement portion of the simulation.

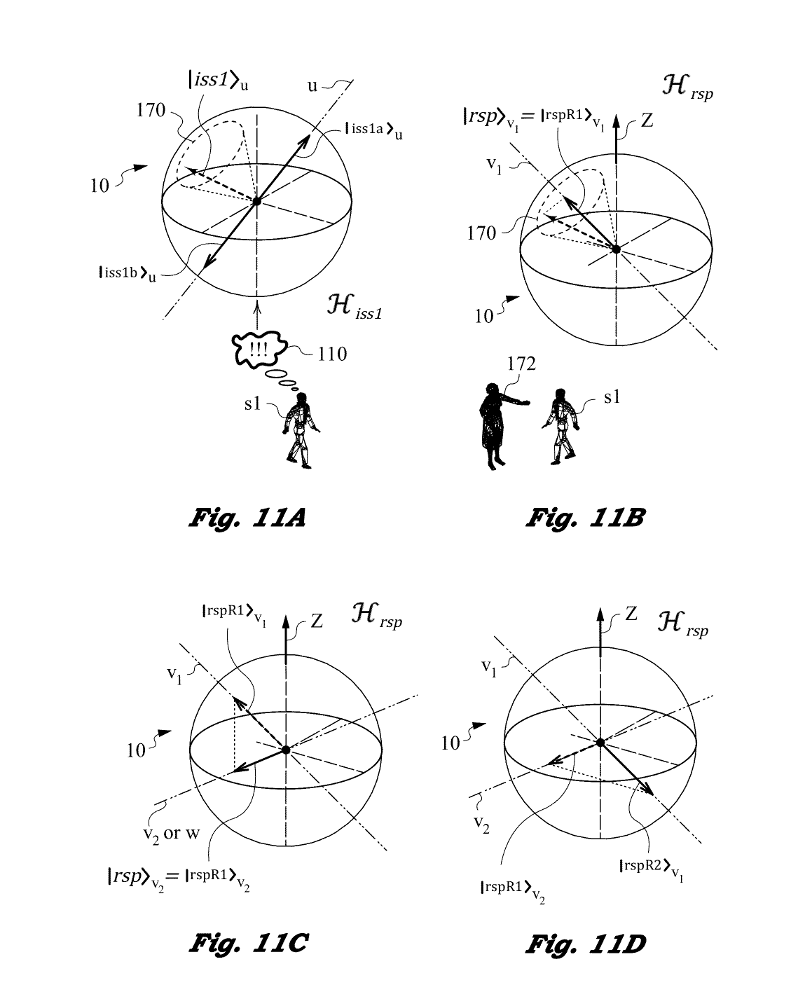

Putting together the teachings above, we turn to still another advantageous embodiment of the method and system of the invention as illustrated in the sequence of FIGS. 11A-D. The situations depicted represent a polling activity prepared based on the quantum representation of the present invention. In FIG. 11A subject s1 is shown with his or her assigned subject qubit |iss1 [symbol] residing within a cone angle 170 in Bloch sphere 10 as dictated by the various sources of error discussed above.

In a first polling step, a pollster 172 informed by the quantum assignments of the present invention asks subject s1 a question in the context defined by ray vₗ (or value v₁). Given that pollster 172 is well-informed, the question is chosen along vₗ that along the center axis of cone angle 170. This question is intended to provoke collapse of subject qubit |iss1 [symbol] under measurement to an eigenvector either up along vₗ or down along v₁. The intended eigenvector up along vₗ is indicated as |rspR1 [symbol] ᵥ_{₁}.

Apparently, the probability of collapse along positive v₁, which is the intention of pollster 172 is very high. In the art of polling and other social activities such questions are sometimes referred to as “gimmies” or “soft-balls” since their answer by the chosen subject is very likely going to be the intended one. Furthermore, since value vₗ is intentionally selected to be in response space [symbol] ᵣₛₚ there are no further reductions in quantum interaction probability pᵢₙₜ. As a result, after first question pollster 172 has, with a very high event probability γ, prepared subject s1 in pure state |rspR1 [symbol] ᵥ_{₁}.

In a second step illustrated in FIG. 11C, pollster 172 asks a question much more challenging to subject s1 given his or her state |rspR1 [symbol] ᵥ_{₁}. This next question is along value v₂ and the desired outcome is a collapse of state |rspR1 [symbol] ᵥ_{₁} up along v₂ to eigenstate |rspR1 [symbol] ᵥ_{₂}. During such “migration” of subject state it is expected by the rules of quantum mechanics that about half of the time (given that vₗ and v₂ are nearly perpendicular) subject s1 will collapse along the unintended v₂ down direction. These are, however, acceptable losses for pollster 172 who is trying to change subjects mind modulo original value v₁.

At this point we should point out that this operation is a quantum mechanical change of basis. In general, basis v₂ could be any other basis w in response space (and is hence so indicated in FIG. 11C). This type of basis change can be performed in some embodiments by assignment module 116 to migrate a response qubit |rsp [symbol] from a v-basis decomposition to a w-basis decomposition for other purposes than those of pollster 172.

In the third and final question, as illustrated in FIG. 11D, pollster 172 asks a question intended to collapse eigenstate |rspR1 [symbol] ᵥ_{₂} along value v₁, but this time along the negative direction. In other words, pollster 172 has selected the question to provoke a reversal of the original position of subject s1 from their state |rspR1 [symbol] ᵥ_{₁} to |rspR2 [symbol] ᵥ_{₁}.

Quantum mechanics indicates that asking that type of question of subject s1 while he or she is in the |rspR1 [symbol] ᵥ_{₁} state would never produce the desired reversal in position (at least not in a cooperative way or with the subject's full consent). However, because subject was in state |rspR1 [symbol] ᵥ_{₂} immediately prior to being asked the last question, we again have a 50/50 chance of getting the desired result. Thus, after two 50/50 chances and assuming perfect 100% event probability γ, we see how the position of subject s1 modulo value v1 was reversed with slightly less than 25% probability. The fact that it is slightly less accounts for the less than 100% probability for the original “gimmie” question.

In practice, of course, the probability of opinion reversal would be lower, since the challenging questions cannot be expected to carry a 100% quantum interaction probability pᵢₙₜ. Furthermore, the classical probabilities of non-engagement or null response will clearly also come into play and reduce the overall event probability γ. Nevertheless, the underlying quantum mechanical prescription for changing someone's mind is in compliance and illustrative of the methods according to the present invention.

It should also be remarked that the above phenomenon, sometimes referred to as path-dependence or successive changes in framing, can be orchestrated with more intervening questions to reduce the likelihood of subject disengagement or null response. Of course, the path would then become longer and the cumulative reduction in probability of reaching the desired reversal would make such a course of questioning inefficient. Of course, the three step process could be jarring. For example, the “gimmie” question could be “do you like so and so?” while knowing full well that the answer is very likely yes. The first challenging question could be “do you know so and so comes from such and such background?” while cognizant of the fact that subject s1 does not like such background. Now, clearly, the last challenging question is again “do you like so and so?” or its semantic equivalent.

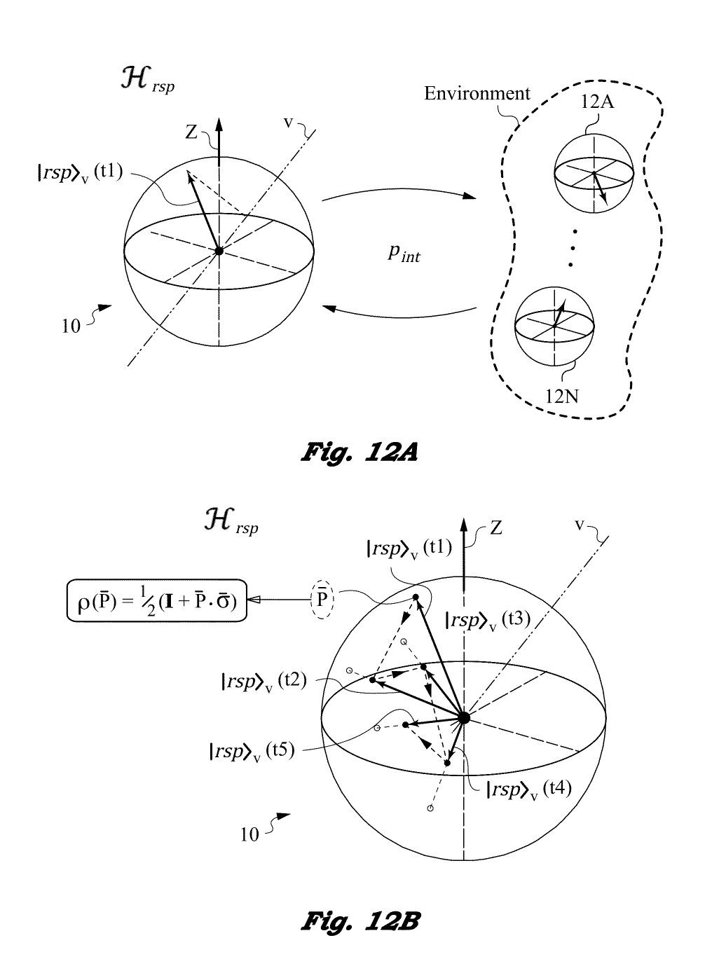

We now come to the last source of errors in the quantum mechanical model, namely decoherence due to unforeseen interactions. FIG. 12A is a diagram that illustrates this fundamental source or error. Here qubit |rsp [symbol] ᵥ(t1) of subject s1 time-stamped at time (t1). Qubit |rsp [symbol] ᵥ(t1) may even be confirmed in pure state, e.g., by preparation through measurement. However, after time (t1) it is subject to interactions with an unknown environment composed of various qubits 12A through 12N. The associated interaction probability pᵢₙₜ is sufficiently high that starting at time (t1) until measurement time we have to expect at least one or more interactions. This brings us back to the realm of quantum entanglement brought up in the last portion of the background section.

FIG. 12B is a diagram showing how the density matrix ρᵣₛₚ( P̅) indicated by point P̅ drawn in by full circles might evolve over time from (t1) through (t5). The density matrix ρᵣₛₚ itself is exactly as described by Eq. 17. As seen from the fact that point P̅ quickly recedes from the surface of Bloch sphere 10 and remains in an entangled state inside the ball, this situation will prevent clean measurements of the type described above. In particular, a mixed state described by density matrix ρᵣₛₚ, unlike a pure state, is not a unique description of the quantum state. Hence, some information will necessarily be lost in transitioning to the density matrix formalism.

In standard applied physics the use of the density matrix is virtually unavoidable since most states encountered in nature are mixed (not pure). Hence, the person skilled in the art will find that the attendant mathematical tools are well developed and can be applied herein. In addition, there is no downside to using the density matrix formalism even when dealing with pure states, since in those cases the density matrix reduces to a simple projection onto a single eigenvector. The problem that the density matrix is never unique, except for pure states at the surface of Bloch sphere 10, unfortunately cannot be circumvented by any presently known methods.

This is why the present quantum model for predicting subject responses is preferably practiced under conditions of honest self-reports with expectation of pure or ideal quantum states for at least certain amounts of time. The same goes for response qubits. However, even with provisions more difficult real-world situations in which the quantum states of interest are mixed, the density matrix will still produce useful output. In particular, the ability to predict expectation value [symbol] PR [symbol] ᵣₛₚ is not lost under entanglement. The present invention provides for computing the expectation value [symbol] PR [symbol] ᵣₛₚ under interaction of the reaction qubit |rsp [symbol] with the environment. Once the density matrix ρᵣₛₚ to properly represent reaction qubit |rsp [symbol] in its mixed state is found the expectation value is represented in its well-known form as:

Tr[PRᵣₛₚρrsp], Eq. 24

where Tr stands for the trace of the matrix product.

Here again the availability of “big data” comes to the rescue. Determination of density matrix ρᵣₛₚ requires large number statistics and, in the case of uncontrolled temporal evolution shown in FIG. 12B, frequent re-computation.

It is also possible and in many embodiments desirable to assign additional internal states of the subject to corresponding qubits. The system and method of invention support the assignment by assignment module 116 of a secondary internal state of subject s1 to a second subject qubit |iss2 [symbol] . Such assignment should be followed by testing for quantum entanglement between the first subject qubit |iss1 [symbol] and the second subject qubit |iss2 [symbol] to better determine the usefulness of the combination. This is done by applying the standard methods known to those skilled in the art as well as the above-introduced density matrix formalism. It is crucial to ensure that the combination of two subject qubits be useful in making predictions about responses of the subject modulo propositions. Otherwise the dramatic increase in complexity of the model that deploys two potentially entangled qubits to describe the subject may be counterproductive.

Note that the relationship of first subject qubit |iss1 [symbol] and second subject qubit |iss2 [symbol] is not posited a priori. In other words, no a priori assumptions are made about the relationship between the Hilbert spaces [symbol] ᵢₛₛ₁ and [symbol] ᵢₛₛ₂ of the two qubits (i.e., we do not presume tensor product space [symbol] ᵢₛₛ₁ [symbol] [symbol] ᵢₛₛ₂). Thus, there is no initial assumption made about any potential state of entanglement between qubits |iss1 [symbol] and |iss2 [symbol] . Instead, quantum entanglement between qubits |iss1 [symbol] , |iss2 [symbol] can be tested with the aid of “big data”. This is done under the above-stated assumption that first and second qubits |iss1 [symbol] , |iss2 [symbol] are reasonably pure from general entanglement with the environment (i.e., relationship with qubits not under consideration that would present a theoretical obstacle to obtaining any indications of entanglement between just the two qubits in question).

Computer system 100 implementing the quantum model can be local or distributed. In fact, given the large quantities of data involved, it is preferable that computer system 100 be implemented in a cluster setting where independent nodes may assume the roles of the different modules. Network behavior monitoring unit 120, which is typically a remote unit or even part of a social network hosting infrastructure, could also be connected to simulation engine 126. It will thus be able to receive a sampling of occurrences of the most probable response and perform some internal tuning based on this data.

It will be evident to a person skilled in the art that the present invention admits of various other embodiments. Therefore, its scope should be judged by the claims and their legal equivalents.

1. A computer implemented method for predicting a most probable response of a subject to a proposition having at least two mutually exclusive responses, said method comprising:
a) storing in a memory measurable indications a, b of a primary internal state of said subject;
b) assigning by an assignment module said primary internal state of said subject to a first subject qubit |iss1 [symbol] having a u-basis decomposition into at least two subject state eigenvectors |iss1a [symbol] ᵤ, |iss1b [symbol] ᵤ with at least two subject state eigenvalues λₐ, λ_{b} corresponding to said measurable indications a, b of said primary internal state;
c) assigning by said assignment module a response qubit |rsp [symbol] to said subject modulo said proposition, said response qubit |rsp [symbol] having a v-basis decomposition into subject response eigenvectors |rspR1 [symbol] ᵥ, |rspR2 [symbol] ᵥ with subject response eigenvalues λ_{R1}, λ_{R2} corresponding to said at least two mutually exclusive responses R1, R2;
d) assigning by said assignment module to said proposition a proposition matrix PR exhibiting said response eigenvectors |rspR1 [symbol] ᵥ, |rspR2 [symbol] ᵥ;
e) curating in a statistics module an event probability γ based on said first subject qubit |iss1 [symbol] for said subject confronting said proposition to yield a quantum measurement of said response qubit |rsp [symbol] ; and
f) predicting by a prediction module said most probable response from a quantum expectation value [symbol] PR [symbol] ᵣₛₚ of said proposition matrix PR.

2. The method of claim 1, further comprising:
a) curating by a network behavior monitoring unit estimated quantum probabilities pₐ, p_{b} of observing said primary internal state yield measureable indications a, b to quantum measurement; and
b) expressing said u-basis decomposition as |iss1 [symbol] =αₐ|iss1a [symbol] ᵤ+β_{b}|iss1b [symbol] ᵤ, where αₐ and β_{b} are complex coefficients; and
c) setting said estimated quantum probabilities pₐ, p_{b} equal to complex coefficient norms α*ₐαₐ and β*_{b}β_{b}.

3. The method of claim 1, further comprising:
a) curating by a network behavior monitoring unit estimated quantum probabilities p_{R1}, p_{R2} of observing said at least two mutually exclusive responses R1, R2 to said quantum measurement of said response qubit |rsp [symbol] ;
b) expressing said v-basis decomposition as |rsp [symbol] =α_{R1}a |rspR1 [symbol] ᵥ+β_{R2}|rspR2 [symbol] ᵥ, where α_{R1} and β_{R2} are complex coefficients; and
c) setting said estimated quantum probabilities p_{R2}, p_{R2} equal to complex coefficient norms α*_{R1}α_{R1} and β*_{R2}β_{R2}.

4. The method of claim 3, further comprising:
a) seeding a random event mechanism with said estimated quantum probabilities p_{R1}, p_{R2}; and
b) simulating with a simulation engine the occurrence of said at least two mutually exclusive responses R1, R2 for said subject.

5. The method of claim 1, further comprising simulating with a simulation engine occurrences of said most probable response for said subject.

6. The method of claim 5, further comprising connecting said simulation engine to a network behavior monitoring unit to provide a sampling of said occurrences.

7. The method of claim 1, further comprising estimating by said statistics module a basis relationship between said first subject qubit |iss1 [symbol] in said u-basis decomposition and said response qubit |rsp [symbol] in said v-basis decomposition.

8. The method of claim 7, wherein said event probability γ is adjusted by said statistics module by a quantum interaction probability pᵢₙₜ that is based on said basis relationship.

9. The method of claim 7, further comprising the steps of:
a) determining a basis misalignment between a u-ray defining said u-basis and a v-ray defining said v-basis; and
b) adjusting said event probability γ by a quantum interaction probability pᵢₙₜ that is based on said basis misalignment.

10. The method of claim 1, wherein said event probability γ is adjusted by said statistics module by at least one classical probability selected from the group consisting of a null response probability pₙᵤₗₗ to said proposition by said subject, a non-engagement probability pₙₑ of said subject not engaging with said proposition.

11. The method of claim 1, further comprising:
a) performing a basis change by said assignment module to migrate said response qubit |rsp [symbol] from said v-basis decomposition to a w-basis decomposition;
b) predicting by said prediction module a most probable response of said subject in said w-basis decomposition of said response qubit |rsp [symbol] .

12. The method of claim 1, further comprising the steps of:
a) placing said first subject qubit |iss1 [symbol] in a subject space [symbol] ᵢₛₛ₁;
b) placing said response qubit |rsp [symbol] in a response space [symbol] ᵣₛₚ;
c) determining a space relationship between said subject space [symbol] ᵢₛₛ₁ and said response space [symbol] ᵣₛₚ; and
d) adjusting said event probability γ based on said space relationship.

13. The method of claim 1, wherein said quantum expectation value [symbol] PR [symbol] ᵣₛₚ is computed under interaction of said response qubit |rsp [symbol] with an environment thereby inducing a density matrix ρᵣₛₚ, such that said quantum expectation value is represented by Tr[PRᵣₛₚρᵣₛₚ].

14. The method of claim 1, wherein said first subject qubit |iss1 [symbol] is represented by a pure state.

15. The method of claim 14, wherein said pure state is adjusted by a perturbation.

16. The method of claim 14, wherein said primary internal state is selected from the group consisting of a Jungian type, a Big 5 type, a personality trait, a preference, an attribute and a proclivity.

17. The method of claim 16, wherein said primary internal state is inferred from a documented online presence of said subject.

18. The method of claim 16, wherein said primary internal state is determined form a self-report of said subject about said primary internal state.

19. The method of claim 1, further comprising assigning by said assignment module a secondary internal state of said subject to a second subject qubit |iss2 [symbol] .

20. The method of claim 19, further comprising the step of testing for quantum entanglement between said first subject qubit |iss1 [symbol] and said second subject qubit |iss2 [symbol] .

21. A computer system for predicting a most probable response of a subject to a proposition having at least two mutually exclusive responses, said computer system comprising:
a) a memory for storing measurable indications a, b of a primary internal state of said subject;
b) an assignment module for making assignments including:
i) assigning said primary internal state of said subject to a first subject qubit |iss1 [symbol] having a u-basis decomposition into at least two subject state eigenvectors |iss1a [symbol] ᵤ, |iss1b [symbol] ᵤ with at least two subject state eigenvalues λₐ, λ_{b} corresponding to said measurable indications a, b of said primary internal state;
ii) assigning a response qubit |rsp [symbol] to said subject modulo said proposition, said response qubit |rsp [symbol] having a v-basis decomposition into subject response eigenvectors |rspR1 [symbol] ᵥ, |rspR2 [symbol] ᵥ with subject response eigenvalues λ_{R1}, λ_{R2} corresponding to said at least two mutually exclusive responses R1, R2;
iii) assigning to said proposition a proposition matrix PR exhibiting said response eigenvectors |rspR1 [symbol] ᵥ, |rspR2 [symbol] ᵥ;
c) a statistics module for curating an event probability γ based on said first subject qubit |iss1 [symbol] for said subject confronting said proposition to yield a quantum measurement of said response qubit |rsp [symbol] ; and
d) a prediction module for predicting said most probable response from a quantum expectation value [symbol] PR [symbol] ᵣₛₚ of said proposition matrix PR.

22. The computer system of claim 21, wherein said modules are implemented in nodes of a computer cluster.

23. The computer system of claim 21, further comprising a simulation engine for performing simulations based at least in part on said most probable response predicted by said prediction module.

24. The computer system of claim 23, further comprising a network behavior monitoring unit connected to said simulation engine for receiving a sampling of occurrences of said most probable response.
